(19) United States
(12) Patent Application Publication
(10) Pub. No.: US 2003/0213939 A1
(43) Pub. Date: Nov. 20, 2003

(54) Electrically conductive polymeric foams and elastomers and methods of manufacture thereof

(76) Inventors: Sujatha Narayan, Putnam, CT (US); Michael D. Bessette, Storrs, CT (US); Murali Sethumadhavan, Shrewsbury, MA (US); Sueng B. Chun, Pomfret Center, CT (US)

Correspondence Address: CANTOR COLBURN LLP, 55 Griffin Road South, Bloomfield, CT, 06002, US

(21) Appl. No.: 10/404,923

(22) Filed: Apr. 1, 2003

Related U.S. Application Data
(60) Provisional application No. 60/369,463, filed on Apr. 1, 2002.

(51) Int. Cl. H01B 1/00

(52) U.S. Cl. 252/500

(57) ABSTRACT

An electrically conductive composition comprises a polymeric foam and carbon nanotubes. The composition has a volume resistivity of about 10⁻³ ohm-cm to about 10⁸ ohm-cm. In another embodiment, an electrically conductive elastomeric composition comprises an elastomer and carbon nanotubes, and has a volume resistivity of about 10⁻³ ohm-cm to about 10³ ohm-cm. The polymeric foams and elastomers retain their desirable physical properties, such as compressibility, flexibility and compression set resistance. They are of particular use as that articles provide electromagnetic shielding and/or electrostatic dissipation, especially for applications involving complicated geometries, such as in computers, personal digital assistants, cell phones, medical diagnostics, and other wireless digital devices, electronic goods such as cassette and digital versatile disk players, as well as in automobiles, ships and aircraft, and the like, where high strength to weight ratios are desirable.

### CROSS-REFERENCE TO RELATED APPLICATIONS

This application claims priority to U.S. Provisional Application 60/369,463 filed Apr. 1, 2002, the entire contents of which are incorporated herein by reference.

### BACKGROUND

This disclosure relates to electrically conductive polymeric foams and elastomers and the methods of manufacture thereof, and in particular to electrically conductive polymeric foams and elastomers for electromagnetic shielding and electrostatic dissipation.

Polymer foams and elastomers comprising electrically conductive fillers are widely used for a variety of purposes, for example as gaskets or seals in electronic goods, computers, medical devices, and the like, for providing electromagnetic shielding and/or electrostatic dissipation. In the past, metals have generally been used to provide electrical conductivity. However, with the increasing miniaturization of electronic components and the use of plastic parts, particularly in consumer electronics, there remains a need for newer, lighter materials. Current gasket materials capable of electromagnetic shielding include, for example, beryllium-copper finger stock, metal foil or metallized fabric wrapped around non-conductive foam gaskets (hereinafter FOF), non-conductive gaskets coated with conductive materials, highly filled-expanded polytetrafluoroethylene (PTFE), and metal-based fillers loaded into silicone resins. However, these materials lack the requisite combination of effective electromagnetic shielding, softness, and the ability to be formed into thin cross sections. For example, FOF gaskets are soft and highly compressible, but are not readily formed into complex shapes or shapes having thin cross-sections (e.g., less than about 760 micrometers (30 mils)), without leaving gaps. Filled, expanded PTFE compositions are soft, but lack physical strength, high electrical conductivity, and adequate compression set resistance.

The use of polymer compositions instead of metals or metal-coated polymers has opened new avenues for applications involving shielding. For example, U.S. Pat. No. 6,265,466 to Glatkowski et al. describes an electromagnetic shielding composite having oriented carbon nanotubes, wherein the orientation is achieved by the application of a shearing force. Similarly, U.S. Pat. Nos. 5,591,382 and 5,643,502 to Nahass disclose high strength conductive polymers comprising carbon fibrils having a notched Izod of greater than about 10 kilogram centimeter/centimeter (kg-cm/cm) (2 ft-lbs/inch) and a volume resistivity of less than 1×10¹¹ ohm-cm for use in automotive applications. However, these attempts to formulate electrically conductive polymeric composites have generally resulted in stiff materials wherein intrinsic properties such as compressibility, flexibility, compression set resistance, impact strength, ductility, elasticity, and the like, are adversely affected. There accordingly remains a need in the art for polymeric compositions, especially elastomers and polymeric foams, that are effective in providing electrical conductivity, particularly electromagnetic shielding and/or electrostatic dissipation, while better retaining advantageous intrinsic physical properties such as flexibility and ductility.

### SUMMARY

The above drawbacks and disadvantages are alleviated by a composition comprising a polymeric foam and carbon nanotubes, wherein the composition has a volume resistivity of about 10⁻³ ohm-cm to about 10⁸ ohm-cm.

In another embodiment, an elastomeric composition comprises an elastomer and carbon nanotubes, wherein the composition has a volume resistivity of about 10⁻³ ohm-cm to about 10³ ohm-cm.

The above-described polymeric foams and elastomers are electrically conductive, but retain the desirable physical properties of the polymeric foams and elastomers, such as compressibility, flexibility, compression set resistance, cell uniformity (in the case of foams), and the like. These materials can accordingly be used to form electrically conductive articles, in particular articles that can provide electromagnetic shielding and/or electrostatic dissipation. Uses include applications involving complicated geometries and forms, such as in computers, personal digital assistants, cell phones, medical diagnostics, and other wireless digital devices, electronic goods such as cassette and digital versatile disk players, as well as in automobiles, ships and aircraft, and the like, where high strength to weight ratios are desirable.

### DETAILED DESCRIPTION

Disclosed herein are polymeric foams and elastomers comprising carbon nanotubes. The amount of carbon nanotubes (and other optional fillers) is preferably selected so as to provide electrical conductivity, particularly electromagnetic shielding and/or electrostatic dissipation while generally retaining the advantageous intrinsic physical properties of the polymeric foams or elastomers. As used herein the “intrinsic physical properties” of the polymeric foams or elastomers refers to the physical properties of the corresponding polymeric foam or elastomer composition without carbon nanotubes. In a particularly advantageous feature, it has been discovered that the addition of carbon nanotubes to the polymeric foams, particularly in quantities effective to provide a volume resistivity of less than or equal to about 10⁸ ohm-cm, does not adversely alter the viscosity of the foamable composition and therefore does not adversely disrupt or change the foaming process or the equipment for foaming.

The polymer for use in the polymeric electrically conductive polymeric foams may be selected from a wide variety of thermoplastic resins, blends of thermoplastic resins, or thermosetting resins. Examples of thermoplastic resins that may be used in the polymeric foams include polyacetals, polyacrylics, styrene acrylonitrile, acrylonitrile-butadiene-styrene, polyurethanes, polycarbonates, polystyrenes, polyethylenes, polypropylenes, polyethylene terephthalates, polybutylene terephthalates, polyamides such as, but not limited to Nylon 6, Nylon 6,6, Nylon 6,10, Nylon 6,12, Nylon 11 or Nylon 12, polyamideimides, polyarylates, polyurethanes, ethylene propylene rubbers (EPR), polyarylsulfones, polyethersulfones, polyphenylene sulfides, polyvinyl chlorides, polysulfones, polyetherimides, polytetrafluoroethylenes, fluorinated ethylene propylenes, polychlorotrifluoroethylenes, polyvinylidene fluorides, polyvinyl fluorides, polyetherketones, polyether etherketones, polyether ketone ketones, or the like, or combinations comprising at least one of the foregoing thermoplastic resins.

Examples of blends of thermoplastic resins that may be used in the polymeric foams include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, polyethylene terephthalate/polybutylene terephthalate, styrene-maleic anhydride/acrylonitrile-butadiene-styrene, polyether etherketone/polyethersulfone, styrene-butadiene rubber, polyethylene/nylon, polyethylene/polyacetal, ethylene propylene rubber (EPR) or the like, or combinations comprising at least one of the foregoing blends.

Examples of polymeric thermosetting resins that may be used in the polymeric foams include polyurethanes, natural rubber, synthetic rubber, ethylene propylene diene monomer (EPDM), epoxys, phenolics, polyesters, polyamides, silicones, or the like, or combinations comprising at least one of the foregoing thermosetting resins. Blends of thermosetting resins as well as blends of thermoplastic resins with thermosetting resins may be utilized in the polymeric foams.

The polymers for use in the electrically conductive elastomers include those having an intrinsic Shore A Hardness of less than or equal to about 80, preferably less than or equal to about 60, and more preferably less than or equal to about 40, and include thermosetting resins such as styrene butadiene rubber (SBR), EPDM, polyurethanes, and silicones as well as thermoplastic resins such as EPR, and elastomers derived from polyacrylics, polyurethanes, polyolefins, polyvinyl chlorides, or combinations comprising at least one of the foregoing elastomeric materials.

As used herein, the term “carbon nanotube” is inclusive of a variety of very small carbon fibers having average diameters of less than or equal to about 2000 nanometers (nm) and having graphitic or partially graphitic structures. Suitable carbon nanotubes include those wherein the outer surface of the graphitic or carbon layers is derivatized, for example bonded to a plurality of oxygen-containing groups such as carbonyl, carboxylic acid, carboxylic acid ester, epoxy, vinyl ester, hydroxy, alkoxy, isocyanate, or amide group, or derivatives thereof, for example, sulfhydryl, amino, or imino groups.

Suitable carbon nanotubes for imparting electrical conductivity to the polymeric foams and elastomers have diameters of about 0.5 to about 2000 nm, with aspect ratios greater than or equal to about 5. Preferably, the carbon nanotubes have an aspect ratio greater than or equal to about 10, more preferably greater than or equal to about 100, and even more preferably greater than or equal to about 1000. Carbon nanotubes as defined herein include vapor grown carbon nanofibers (VGCF) and multi-wall and single carbon nanotubes obtained from processes such as laser ablation, carbon arc, chemical vapor deposition and other processes.

The VGCF have diameters of about 3.5 to about 2000 nm and are generally produced by chemical vapor deposition. Within this range, the VGCF generally have diameters of greater than or equal to about 3, preferably greater than or equal to about 4.5, and more preferably greater than or equal to about 5 nm. Also desirable within this range are diameters of less than or equal to about 1000, preferably less than or equal to about 500, and more preferably less than or equal to about 100, and even more preferably less than or equal to about 50 nm. The VGCF may be hollow or solid and may have outer surfaces comprising amorphous or graphitic carbon. Solid VGCF are often referred to as carbon nanofibers. VGCF typically exist in the form of clusters, often referred to as aggregates or agglomerates, which may or may not contain embedded catalyst particles utilized in their production.

VGCF are generally used in an amount of about 0.0001 to about 50 weight percent (wt %) of the total weight of the composition. Within this range, it is generally desirable to use an amount greater than or equal to about 0.0025, preferably greater than or equal to about 0.5, and more preferably greater than or equal to about 1 wt % of the total weight of the composition. In general, it is also desirable to have the VGCF present in an amount less than or equal to about 40, preferably less than or equal to about 20, more preferably less than or equal to about 5 wt % of the total weight of the composition.

Other carbon nanotubes are presently produced by laser-evaporation of graphite or by carbon arc synthesis, yielding fullerene-related structures that comprise graphene cylinders that may be open or closed at either end with caps containing pentagonal and/or hexagonal rings. These nanotubes may have a single wall of carbon, and are therefore generally called single wall carbon nanotubes. Preferred single wall carbon nanotubes have a diameter of about 0.5 to about 3 nm. Within this range it is desirable to use single wall carbon nanotubes having diameters of greater than or equal to about 0.6, preferably greater than or equal to about 0.7 nm. Also desirable within this range are single wall carbon nanotubes having diameters less than or equal to about 2.8, preferably less than or equal to about 2.7, and more preferably less than or equal to about 2.5 nm.

Carbon nanotubes having multiple concentrically arranged walls produced by laser-evaporation of graphite or by carbon arc synthesis are generally called multiwall carbon nanotubes. Multiwall nanotubes used in the polymeric foams and elastomers generally have diameters of about 2 nm to about 50 nm. Within this range it is generally desirable to have diameters greater than or equal to about 3, preferably greater than or equal to about 4, and more preferably greater than or equal to about 5 nm. Also desirable within this range are diameters of less than or equal to about 45, preferably less than or equal to about 40, more preferably less than or equal to about 35, even more preferably less than or equal to about 25, and most preferably less than or equal to about 20 nm. Single wall or multiwall carbon nanotubes generally exist in the form of clusters, (also often referred to as agglomerates and aggregates) and may or may not contain embedded catalyst particles utilized in their production. Single wall carbon nanotubes tend to exist in the form of ropes due to Van der Waal forces, and clusters formed by these ropes may also be used. Single wall nanotubes may be metallic or semi-conducting. It is preferable to use compositions having as high a weight percentage of metallic carbon nanotubes as possible for purposes of electromagnetic shielding.

Single and/or multiwall carbon nanotubes are used in amounts effective to provide the desired conductivity, generally in an amount of about 0.0001 to about 50 wt % of the total weight of the polymeric foam or elastomer composition. Within this range, it is generally desirable to have the single and/or multiwall nanotubes present in an amount of greater than or equal to about 0.05, preferably greater than or equal to about 0.1 of the total weight of the polymeric foam or elastomer composition. Also desirable are single and/or multiwall carbon nanotubes present in an amount less than or equal to about 40, preferably less than or equal to about 20, and more preferably less than or equal to about 5 wt % of the total weight of the polymeric foam or elastomer composition.

Carbon nanotubes containing impurities such as amorphous carbon or soot, as well as catalytic materials such as iron, nickel, copper, aluminum, yttrium, cobalt, sulfur, platinum, gold, silver, or the like, or combinations comprising at least one of the foregoing catalytic materials, may also be used. In one embodiment, the carbon nanotubes may contain impurities in an amount less than or equal to about 80 weight percent (wt %), preferably less than or equal to about 60 wt %, more preferably less than or equal to about 40 wt %, and most preferably less than or equal to about 20 wt %, based upon the total weight of the carbon nanotubes and the impurities.

Other electrically conductive fillers such as carbon black, carbon fibers such as PAN fibers, metal-coated fibers or spheres such as metal-coated glass fibers, metal-coated carbon fibers, metal-coated organic fibers, metal coated ceramic spheres, metal coated glass beads and the like, inherently conductive polymers such as polyaniline, polypyrrole, polythiophene in particulate or fibril form, conductive metal oxides such as tin oxide or indium tin oxide, and combinations comprising at least one of the foregoing conductive fillers may also be used. The amount of these fillers is preferably selected so as to not adversely affect the final properties of the polymeric foams and elastomers. Typical amounts, when present, are about 0.1 to about 80 wt % based on the total weight of the composition. Within this range it is generally desirable to have an amount of greater than or equal to about 1.0, preferably greater than or equal to about 5 wt % of the total weight of the composition. Also desirable is an amount of less than or equal to about 70, more preferably less than or equal to about 65 wt %, of the total weight of the composition.

In addition to the electrically conducting fillers, other fillers, e.g., reinforcing fillers such as silica may also be present. In a preferred embodiment, a thermally conductive or thermally non-conductive filler is used to provide thermal management as well as electrical conductivity. Known thermally conductive fillers include metal oxides, nitrides, carbonates, or carbides (hereinafter sometimes referred to as “ceramic additives”). Such additives may be in the form of powder, flake, or fibers. Exemplary materials include oxides, carbides, carbonates, and nitrides of tin, zinc, copper, molybdenum, calcium, titanium, zirconium, boron, silicon, yttrium, aluminum or magnesium, or, mica, glass ceramic materials or fused silica. When present, the thermally conductive materials are added in quantities effective to achieve the desired thermal conductivity, generally an amount of about 10 to about 500 weight parts. Within this range, it is desirable to add the thermally conductive materials in an amount of greater than or equal to about 30, preferably greater than or equal to about 75 weight parts based on the total weight of the composition. Also desirable within this range is an amount of less than or equal to about 150 weight parts, preferably less than or equal to about 100 weight parts based on the total weight of the composition.

Manufacture of the various polymeric foams and elastomers is generally by processes recognized in the art. In general, the polymeric resins (in the case of thermoplastic resins and resin blends) or composition for the formation of the polymer (in the case of thermosetting resins), additives, e.g., catalyst, crosslinking agent, additional fillers, and the like, and the carbon nanotubes are mixed, frothed and/or blown if desired, shaped (e.g., cast or molded), then cured, if applicable. Stepwise addition of the various components may also be used, e.g., the carbon nanotubes may be provided in the form of a masterbatch, and added downstream, for example in an extruder. The foams may be produced in the form of sheets, tubes, or chemically or physically blown bun stock materials. The elastomers are generally produced in the form of sheets, tubes, conduits, slabs, meshes, or the like, or combinations comprising at least one of the foregoing form.

During manufacture, it is generally desirable to disentangle any clusters, aggregates or agglomerates of carbon nanotubes with minimal damage to the aspect ratio, in order to provide enhanced electrical conductivity, in particular enhanced electromagnetic shielding or electrostatic dissipative properties at lower weight percentages of nanotubes. While reducing the viscosity during the manufacturing of elastomers and polymeric foams is not generally undertaken, it may be desirable that any mixing during manufacture be carried out at as low a viscosity as possible, as mixing at lower viscosities substantially reduces the shear forces acting on the nanotubes. Accordingly, when a composition is to be processed into an elastomer in an extruder, it may be desirable to introduce a removable diluent into the melt prior to the introduction of the nanotubes, to substantially reduce the melt viscosity of the composition. The diluent may be removed after some or all of the dispersion of the nanotubes in the elastomer is completed.

Similarly, in the preparation of the polymeric foams it is desirable to introduce desired blowing agents into the polymeric resin prior to the introduction of the nanotubes to facilitate dispersion while minimizing damage to the nanotubes. The blowing of the foam produces a similar effect, in that it disentangles nanotubes with low or minimal damage to the aspect ratio, because the expansion of any polymer trapped in a nanotube cluster or agglomerate or aggregate will cause the disentangling of the individual nanotubes with minimal damage. Thus, mixing nanotubes with the polymer at a reduced viscosities and subsequently foaming the polymer may achieve excellent conductivity at low loading levels, because of the preservation of nanotube aspect ratio. Low carbon nanotube loading aids in preserving the desirable physical properties of the elastomers and the polymeric foams.

As stated above, production of prior art electrically conductive polymeric foams is often achieved by use of a large amount of electrically conductive filler, which can adversely affect foam properties such as softness. It also produces a high density foam despite the fact that the void content (also commonly referred to as porosity) is high. The relationship between void content and the foam density is given by the expression

Void Content=1−(foam density/matrix specific gravity)

wherein the matrix specific gravity refers to the specific gravity of the polymeric material used in the foam. It is therefore desirable to have as low a density as possible while having a void content as high possible in the electrically conductive polymeric foams. As used herein, “foams” refers to materials having a cellular structure and densities lower than about 65 pounds per cubic foot (pcf), preferably less than or equal to about 55 pcf, more preferably less than or equal to about 45 pcf, most preferably less than or equal to about 40 pcf. It is also generally desirable to have a void content of about 20 to about 99%, preferably greater than or equal to about 30%, and more preferably greater than or equal to about 50%, each based upon the total volume of the electrically conductive polymeric foam.

Use of carbon nanotubes enables the production of electrically conductive polymeric foams having a volume resistivity of about 10⁻³ ohm-cm to about 10⁸ ohm-cm. Within this range, the volume resistivity can be less than or equal to about 10⁶, less than or equal to about 10⁴, or less than or equal to about 10³, and is preferably less than or equal to about 10², more preferably less than or equal to about 10, and most preferably less than or equal to about 1 ohm-cm.

Use of carbon nanotubes also allows the production of electrically conductive elastomers having Shore A durometer of less than or equal to about 80, preferably less than or equal to about 70, more preferably less than or equal to about 50 and most preferably less than or equal to about 40, as well as a volume resistivity of about 10⁻³ ohm-cm to about 10³ ohm-cm. Within this range it is desirable to have a volume resistivity less than or equal to about 10² ohm-cm. Also desirable within this range is a volume resistivity less than or equal to about 10, and more preferably less than or equal to about 1 ohm-cm.

In a preferred embodiment, the polymeric foams and elastomers may provide electromagnetic shielding in an amount of greater than or equal to about 50 decibels (dB), preferably greater than or equal to about 70 dB, even more preferably greater than or equal to about 80 dB, and most preferably greater than or equal to about 100 dB. Electromagnetic shielding is commonly measured in accordance with MIL-G-83528B.

In a particularly preferred embodiment, the volume resistivity of the polymeric foam and/or elastomer is less than or equal to about 1, and the electromagnetic shielding is greater than or equal to about 80 dB.

Polyurethane foams and elastomers, polyolefin foams and elastomers, and silicone foams and elastomers are particularly suited for use in the present invention.

In general, polyurethane foams and elastomers are formed from compositions comprising an organic polyisocyanate component, an active hydrogen-containing component reactive with the polyisocyanate component, a surfactant, and a catalyst. The process of forming the foam may use chemical or physical blowing agents, or the foam may be mechanically frothed. For example, one process of forming the foam comprises substantially and uniformly dispersing inert gas throughout a mixture of the above-described composition by mechanical beating of the mixture to form a heat curable froth that is substantially structurally and chemically stable, but workable at ambient conditions; and curing the froth to form a cured foam. It may also be desirable to introduce a physical blowing agent into the froth to further reduce foam density during the crosslinking process. In another embodiment, the polyurethane foam is formed from the reactive composition using only physical or chemical blowing agents, without the used of any mechanical frothing.

The organic polyisocyanates used in the preparation of electromagnetically shielding and/or electrostatically dissipative polyurethane elastomers or foams generally comprises isocyanates having the general formula:

Q(NCO)ᵢ

wherein i is an integer of two or more and Q is an organic radical having the valence of i, wherein i has an average value greater than 2. Q may be a substituted or unsubstituted hydrocarbon group (i.e., an alkylene or an arylene group),or a group having the formula Q¹-Z-Q¹ wherein Q¹ is an alkylene or arylene group and Z is —O—, —O-Q¹-S, —CO—, —S—, —S-Q¹—S—, —SO—, —SO₂—, alkylene or arylene. Examples of such polyisocyanates include hexamethylene diisocyanate, 1,8-diisocyanato-p-methane, xylyl diisocyanate, diisocyanatocyclohexane, phenylene diisocyanates, tolylene diisocyanates, including 2,4-tolylene diisocyanate, 2,6-tolylene diisocyanate, and crude tolylene diisocyanate, bis(4-isocyanatophenyl)methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, and polymeric isocyanates such as polymethylene polyphenylisocyanate.

Q may also represent a polyurethane radical having a valence of i in which case Q(NCO)ᵢ is a composition known as a prepolymer. Such prepolymers are formed by reacting a stoichiometric excess of a polyisocyanate as above with an active hydrogen-containing component, especially the polyhydroxyl-containing materials or polyols described below. Usually, for example, the polyisocyanate is employed in proportions of about 30 percent to about 200 percent stoichiometric excess, the stoichiometry being based upon equivalents of isocyanate group per equivalent of hydroxyl in the polyol. The amount of polyisocyanate employed will vary slightly depending upon the nature of the polyurethane being prepared.

The active hydrogen-containing component may comprise polyether polyols and polyester polyols. Suitable polyester polyols are inclusive of polycondensation products of polyols with dicarboxylic acids or ester-forming derivatives thereof (such as anhydrides, esters and halides), polylactone polyols obtainable by ring-opening polymerization of lactones in the presence of polyols, polycarbonate polyols obtainable by reaction of carbonate diesters with polyols, and castor oil polyols. Suitable dicarboxylic acids and derivatives of dicarboxylic acids which are useful for producing polycondensation polyester polyols are aliphatic or cycloaliphatic dicarboxylic acids such as glutaric, adipic, sebacic, fumaric and maleic acids; dimeric acids; aromatic dicarboxylic acids such as, but not limited to phthalic, isophthalic and terephthalic acids; tribasic or higher functional polycarboxylic acids such as pyromellitic acid; as well as anhydrides and second alkyl esters, such as, but not limited to maleic anhydride, phthalic anhydride and dimethyl terephthalate.

Additional active hydrogen-containing components are the polymers of cyclic esters. The preparation of cyclic ester polymers from at least one cyclic ester monomer is well documented in the patent literature as exemplified by U.S. Pat. Nos. 3,021,309 through 3,021,317; 3,169,945; and 2,962,524. Suitable cyclic ester monomers include, but are not limited to δ-valerolactone, ε-caprolactone, zeta-enantholactone, the monoalkyl-valerolactones, e.g., the monomethyl-, monoethyl-, and monohexyl-valerolactones. In general the polyester polyol may comprise caprolactone based polyester polyols, aromatic polyester polyols, ethylene glycol adipate based polyols, and mixtures comprising any one of the foregoing polyester polyols. Polyester polyols made from ε-caprolactones, adipic acid, phthalic anhydride, terephthalic acid or dimethyl esters of terephthalic acid are generally preferred.

The polyether polyols are obtained by the chemical addition of alkylene oxides, such as ethylene oxide, propylene oxide and mixtures thereof, to water or polyhydric organic components, such as ethylene glycol, propylene glycol, trimethylene glycol, 1,2-butylene glycol, 1,3-butanediol, 1,4-butanediol, 1,5-pentanediol, 1,2-hexylene glycol, 1,10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidenebis(p-phenyleneoxy)diethanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5; 1,1,1-tris[2-hydroxyethoxy) methyl]-ethane, 1,1,1 -tris[2-hydroxypropoxy)-methyl] propane, diethylene glycol, dipropylene glycol, pentaerythritol, sorbitol, sucrose, lactose, alpha-methylglucoside, alpha-hydroxyalkylglucoside, novolac resins, phosphoric acid, benzenephosphoric acid, polyphosphoric acids such as tripolyphosphoric acid and tetrapolyphosphoric acid, ternary condensation products, and the like. The alkylene oxides employed in producing polyoxyalkylene polyols normally have from 2 to 4 carbon atoms. Propylene oxide and mixtures of propylene oxide with ethylene oxide are preferred. The polyols listed above may be used per se as the active hydrogen component.

A preferred class of polyether polyols is represented generally by the following formula

R[(OCₙH₂ₙ)_{z}OH]ₐ

wherein R is hydrogen or a polyvalent hydrocarbon radical; a is an integer (i.e., 1 or 2 to 6 to 8) equal to the valence of R, n in each occurrence is an integer from 2 to 4 inclusive (preferably 3) and z in each occurrence is an integer having a value of from 2 to about 200, preferably from 15 to about 100. The preferred polyether polyol comprises a mixture of one or more of dipropylene glycol, 1,4-butanediol, 2-methyl-1,3-propanediol, or the like, or combinations comprising at least one of the foregoing polyether polyols.

Other types of active hydrogen-containing materials which may be utilized are polymer polyol compositions obtained by polymerizing ethylenically unsaturated monomers in a polyol as described in U.S. Pat No. 3,383,351, the disclosure of which is incorporated herein by reference. Suitable monomers for producing such compositions include acrylonitrile, vinyl chloride, styrene, butadiene, vinylidene chloride and other ethylenically unsaturated monomers as identified and described in the above-mentioned U.S. patent. Suitable polyols include those listed and described hereinabove and in U.S. Pat. No. 3,383,351. The polymer polyol compositions may contain from greater than or equal to about 1, preferably greater than or equal to about 5, and more preferably greater than or equal to about 10 wt % monomer polymerized in the polyol where the weight percent is based on the total amount of polyol. It is also generally desirable for the polymer polyol compositions to contain less than or equal to about 70, preferably less than or equal to about 50, more preferably less than or equal to about 40 wt % monomer polymerized in the polyol. Such compositions are conveniently prepared by polymerizing the monomers in the selected polyol at a temperature of 40° C. to 150° C. in the presence of a free radical polymerization catalyst such as peroxides, persulfates, percarbonate, perborates, and azo compounds.

The active hydrogen-containing component may also contain polyhydroxyl-containing compounds, such as hydroxyl-terminated polyhydrocarbons (U.S. Pat. No. 2,877,212); hydroxyl-terminated polyformals (U.S. Pat. No. 2,870,097); fatty acid triglycerides (U.S. Pat. Nos. 2,833,730 and 2,878,601); hydroxyl-terminated polyesters (U.S. Pat. Nos. 2,698,838, 2,921,915, 22,850,476, 2,602,783, 2,811,493, 2,621,166 and 3,169,945); hydroxymethyl-terminated perfluoromethylenes (U.S. Pat. Nos. 2,911,390 and 2,902,473); hydroxyl-terminated polyalkylene ether glycols (U.S. Pat. No. 2,808,391; British Pat. No. 733,624); hydroxyl-terminated polyalkylenearylene ether glycols (U.S. Pat. No. 2,808,391); and hydroxyl-terminated polyalkylene ether triols (U.S. Pat. No. 2,866,774).

The polyols may have hydroxyl numbers that vary over a wide range. In general, the hydroxyl numbers of the polyols, including other cross-linking additives, if employed, may range in an amount of about 28 to about 1000, and higher, preferably about 100 to about 800. The hydroxyl number is defined as the number of milligrams of potassium hydroxide used for the complete neutralization of the hydrolysis product of the fully acetylated derivative prepared from 1 gram of polyol or mixtures of polyols with or without other cross-linking additives. The hydroxyl number may also be defined by the equation:

$$OH = \frac{56.1 \times 1000 \times f}{M . W .}$$

wherein OH is the hydroxyl number of the polyol, f is the average functionality, that is the average number of hydroxyl groups per molecule of polyol, and M.W. is the average molecular weight of the polyol.

Where used, a large number of suitable blowing agents or a mixture of blowing agents are suitable, particularly water. The water reacts with the isocyanate component to yield CO₂ gas, which provides the additional blowing necessary. It is generally desirable to control the curing reaction by selectively employing catalysts, when water is used as the blowing agent. Alternatively, compounds that decompose to liberate gases (e.g., azo compounds) may be also be used.

Especially suitable blowing agents are physical blowing agents comprising hydrogen atom-containing components, which may be used alone or as mixtures with each other or with another type of blowing agent such as water or azo compounds. These blowing agents may be selected from a broad range of materials, including hydrocarbons, ethers, esters and partially halogenated hydrocarbons, ethers and esters, and the like. Typical physical blowing agents have a boiling point between about −50° C. and about 100° C., and preferably between about −50° C. and about 50° C. Among the usable hydrogen-containing blowing agents are the HCFC's (halo chlorofluorocarbons) such as 1,1-dichloro-1-fluoroethane, 1,1-dichloro-2,2,2-trifluoro-ethane, monochlorodifluoromethane, and 1-chloro-1,1-difluoroethane; the HFCs (halo fluorocarbons) such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, and pentafluoroethane; the HFE's (halo fluoroethers) such as methyl-1,1,1-trifluoroethylether and difluoromethyl-1,1,1-trifluoroethylether; and the hydrocarbons such as n-pentane, isopentane, and cyclopentane.

When used, the blowing agents including water generally comprise greater than or equal to 1, preferably greater than or equal to 5 weight percent (wt %) of the polyurethane liquid phase composition. In general, it is desirable to have the blowing agent present in an amount of less than or equal to about 30, preferably less than or equal to 20 wt % of the polyurethane liquid phase composition. When a blowing agent has a boiling point at or below ambient temperature, it is maintained under pressure until mixed with the other components.

Suitable catalysts used to catalyze the reaction of the isocyanate component with the active hydrogen-containing component are known in the art, and are exemplified by organic and inorganic acid salts of, and organometallic derivatives of bismuth, lead, tin, iron, antimony, uranium, cadmium, cobalt, thorium, aluminum, mercury, zinc, nickel, cerium, molybdenum, vanadium, copper, manganese, and zirconium, as well as phosphines and tertiary organic amines. Examples of such catalysts are dibutytin dilaurate, dibutyltin diacetate, stannous octoate, lead octoate, cobalt naphthenate, triethylamine, triethylenediamine, N,N,N′,N′-tetramethylethylenediamine, 1,1,3,3-tetramethylguanidine, N,N,N′N′-tetramethyl-1,3-butanediamine, N,N-dimethylethanolamine, N,N-diethylethanolamine, 1,3,5-tris (N,N-dimethylaminopropyl)-s-hexahydrotriazine, o- and p-(dimethylaminomethyl) phenols, 2,4,6-tris(dimethylaminomethyl) phenol, N,N-dimethylcyclohexylamine, pentamethyldiethylenetriamine, 1,4-diazobicyclo [2.2.2] octane, N-hydroxyl-alkyl quaternary ammonium carboxylates and tetramethylammonium formate, tetramethylammonium acetate, tetramethylammonium 2-ethylhexanoate and the like, as well as compositions comprising any one of the foregoing catalysts.

Metal acetyl acetonates are preferred, based on metals such as aluminum, barium, cadmium, calcium, cerium (III), chromium (III), cobalt (II), cobalt (III), copper (II), indium, iron (II), lanthanum, lead (II), manganese (II), manganese (III), neodymium, nickel (II), palladium (II), potassium, samarium, sodium, terbium, titanium, vanadium, yttrium, zinc and zirconium. A common catalyst is bis(2,4-pentanedionate) nickel (II) (also known as nickel acetylacetonate or diacetylacetonate nickel) and derivatives thereof such as diacetonitrilediacetylacetonato nickel, diphenylnitrilediacetylacetonato nickel, bis(triphenylphosphine)diacetyl acetylacetonato nickel, and the like. Ferric acetylacetonate (FeAA) is particularly preferred, due to its relative stability, good catalytic activity, and lack of toxicity. The metal acetylacetonate is most conveniently added by predissolution in a suitable solvent such as dipropylene glycol or other hydroxyl containing components which will then participate in the reaction and become part of the final product.

In a preferred method of producing the polyurethane foams, the components for producing the foams, i.e., the isocyanate component, the active hydrogen-containing component, surfactant, catalyst, optional blowing agents, carbon nanotubes and other additives are first mixed together then subjected to mechanical frothing with air. Alternatively, the ingredients may be added sequentially to the liquid phase during the mechanical frothing process. The gas phase of the froths is most preferably air because of its cheapness and ready availability. However, if desired, other gases may be used which are gaseous at ambient conditions and which are substantially inert or non-reactive with any component of the liquid phase. Such other gases include, for example, nitrogen, carbon dioxide, and fluorocarbons that are normally gaseous at ambient temperatures. The inert gas is incorporated into the liquid phase by mechanical beating of the liquid phase in high shear equipment such as in a Hobart mixer or an Oakes mixer. The gas may be introduced under pressure as in the usual operation of an Oakes mixer or it may be drawn in from the overlying atmosphere by the beating or whipping action as in a Hobart mixer. The mechanical beating operation preferably is conducted at pressures not greater than 7 to 14 kg/cm² (100 to 200 pounds per square inch (p.s.i.)). Readily available mixing equipment may be used and no special equipment is generally necessary. The amount of inert gas beaten into the liquid phase is controlled by gas flow metering equipment to produce a froth of the desired density. The mechanical beating is conducted over a period of a few seconds in an Oakes mixer, or about 3 to about 30 minutes in a Hobart mixer, or however long it takes to obtain the desired froth density in the mixing equipment employed. The froth as it emerges from the mechanical beating operation is substantially chemically stable and is structurally stable but easily workable at ambient temperatures, e.g., about 10° C. to about 40° C.

The mechanical froth is then laid out on a conveyor belt or a sample holder and placed in an oven at the desired temperature to undergo cure. During this process, the blowing agents may be activated. Curing takes place simultaneously to produce foam that has a desired density and other physical properties.

In a preferred method of preparation of electrically conductive polyurethane elastomers, the components listed above, with the exception of the blowing agent, are mixed together without frothing and cast onto a substrate such as a conveyor belt. A doctor blade may be used to adjust the dimensions of the cast mixture prior to curing.

Preferably, the electrically conductive polyurethane foam and elastomer has mechanical properties similar to those of the same polyurethane foam and elastomer without nanotubes. Desirable properties for an electrically conductive polyurethane foam are a 25% compressive force deflection (CFD) of about 0.007 to about 10.5 kg/cm² (about 0.1 to about 150 psi), an elongation to break of greater than or equal to about 20%, a compression set (50%) of less than or equal to about 30%, and a bulk density of about 1 to about 50 pcf. If auxiliary blowing agents are employed, the resultant foam may have a bulk density as low as about 1 pcf.

Desirable properties for an electrically conductive polyurethane elastomer are an elongation to break of greater than or equal to about 20%, a Shore A Durometer of less than or equal to about 80, and a compression set (50%) of less than or equal to about 30.

Polyolefins may also be used to provide electrically conductive foams and elastomers, particularly foams and elastomers having electromagnetic shielding and/or electrostatic dissipative properties. In general, the polyolefin foams are produced by extrusion, where a blowing agent and a crosslinking agent are incorporated into the melt. Crosslinking may be by irradiation, peroxide, or moisture-induced condensation of a silane, followed by blowing of the foam, which generally occurs outside the extruder upon the removal of pressure. Additional heating may be used outside the extruder to facilitate the blowing and curing reactions. Polyolefin elastomers, on the other hand, generally do not utilize any significant amount of blowing agent prior to curing.

Suitable polyolefins used in the manufacture of foams and elastomers include linear low density polyethylene (LLDPE), low density polyethylene (LDPE), high density polyethylene (HDPE), very low density polyethylene (VLDPE), ethylene vinyl acetate (EVA), polypropylene (PP), ethylene vinyl alcohol (EVOH), EPDM, EPR, and combinations comprising at least one of the foregoing polyolefins.

Polyolefins used in the manufacture of foams and elastomers may be obtained by Zeigler-Natta based polymerization processes or by single site initiated (metallocene catalysts) polymerization processes may also be used. Preferred polyolefins used in the electromagnetically shielding and/or electrostatically dissipative and/or electrically conductive foams and elastomers are those obtained from metallocene catalysts and in particular those obtained from single site catalysts. Common examples of single site catalysts used for the production of polyolefins are alumoxane, and group IV B transition metals such as zirconium, titanium, or hafnium. The preferred polyolefins for use in the foams and elastomers are of a narrow molecular weight distribution and are “essentially linear”. The term essentially linear as defined herein refers to a “linear polymer” with a molecular backbone which is virtually devoid of “long-chain branching,” to the extent that it possess less than or equal to about 0.01 “long-chain branches” per one-thousand carbon atoms. As a result of this combination, the resins exhibit a strength and toughness approaching that of linear low density polyethylenes, but have processability similar to high pressure reactor produced, low density polyethylene.

The preferred “essentially linear” polyolefin resins are characterized by a resin density of about 0.86 gram/cubic centimeter (g-cm⁻³) to about 0.96 g-cm⁻³ , a melt index of about 0.5 decigram/minute (dg/min) to about 100 dg/min at a temperature of 190° C. and a force of 2.10 kilogram (kg) as per ASTM D 1238, a molecular weight distribution of about 1.5 to about 3.5, and a composition distribution breadth index greater than or equal to about 45 percent. The composition distribution breadth index (CDBI) is a measurement of the uniformity of distribution of comonomer to the copolymer molecules, and is determined by the technique of Temperature Rising Elution Fractionation (TREF). As used herein, the CDBI is defined as the weight percent of the copolymer molecules having a comonomer content within 50% (i.e., plus or minus 50%) of the median total molar comonomer content. Unless otherwise indicated, terms such as “comonomer content,” “average comonomer content” and the like refer to the bulk comonomer content of the indicated interpolymer blend, blend component or fraction on a molar basis. For reference, the CDBI of linear poly(ethylene), which is absent of comonomer, is defined to be 100%.

The preferred essentially linear olefin is a copolymer resin of a polyethylene. The essentially linear olefinic copolymers of the present invention are preferably derived from ethylene polymerized with at least one comonomer selected from the group consisting of at least one alpha-unsaturated C₃ to C₂₀ olefin comonomer, and optionally one or more C₃ to C₂₀ polyene.

Generally, the alpha-unsaturated olefin comonomers suitable for use in the foams and elastomers have about 3 to about 20 carbon atoms. Within this range it is generally desirable to have alpha-unsaturated comonomers containing greater than or equal to about 3 carbon atoms. Also desirable within this range are alpha-unsaturated comonomers containing less than or equal to about 16, and preferably less than 8 carbon atoms. Examples of such alpha-unsaturated olefin comonomers used as copolymers with ethylene include propylene, isobutylene, 1-butene, 1-hexene, 3-methyl-1-pentene, 4-methyl-1-pentene, 1-octene, 1-decene, 1-dodecene, styrene, halo- or alkyl-substituted styrene, tetrafluoroethylene, vinyl cyclohexene, vinyl-benzocyclobutane and the like.

The polyenes are straight chain, branched chain or cyclic hydrocarbon dienes having about 3 to about 20 carbon atoms. It is generally desirable for the polyenes to have greater than or equal to about 4, preferably greater than or equal to about 6 carbon atoms. Also desirable within this range, is an amount of less than or equal to about 15 carbon atoms. It is also preferred that the polyene is non-conjugated diene. Examples of such dienes include 1,3-butadiene, 1,4-hexadiene, 1,6-octadiene, 5-methyl-1,4-hexadiene, 3,7-dimethyl-1,6-octadiene, 3,7-dimethyl-1,7-octadiene, 5-ethylidene-2-norbornene and dicyclopentadiene. A preferred diene is 1,4-hexadiene.

Preferably, the polyolefin foams or elastomers comprise either ethylene/alpha-unsaturated olefin copolymers or ethylene/alpha-unsaturated olefin/diene terpolymers. Most preferably, the essentially linear copolymer will comprise ethylene and 1-butene or ethylene and 1-hexene. It is generally desirable to have the comonomer content of the olefin copolymers at about 1 mole percent to about 32 mole percent based on the total moles of monomer. Within this range it is generally desirable to have the comonomer content greater than or equal to about 2, preferably greater than or equal to about 6 mole percent based upon the total moles of monomer. Also desirable within this range is a comonomer content of less than or equal to about 26, preferably less than or equal to about 25 mole percent based on the total moles of monomer.

Suitable polyolefins are produced commercially by Exxon Chemical Company, Baytown, Tex., under the trade name EXACT, and include EXACT 3022, EXACT™ 3024, EXACT™ 3025, EXACT™ 3027, EXACT™ 3028, EXACT™ 3031, EXACT™ 3034, EXACT™ 3035, EXACT™ 3037, EXACT™ 4003, EXACT™ 4024, EXACT™ 4041, EXACT™ 4049, EXACT™ 4050, EXACT™ 4051, EXACT™ 5008, and EXACT™ 8002. Other olefin copolymers are available commercially from Dow Plastics, Midland, Mich. (or DuPont/Dow), under trade names such as ENGAGE and AFFINITY and include CL8001, CL8002, EG8100, EG8150, PL1840, PL1845 (or DuPont/Dow 8445), EG8200, EG8180, GF1550, KC8852, FW1650, PL1880, HF1030, PT1409, CL8003, and D8130 (or XU583-00-01).

While the aforementioned essentially linear olefin polymers and copolymers are most preferred, the addition of other polymers or resins to the composition may result in certain advantages in the economic, physical and handling characteristics of the cellular articles. Examples of suitable additive polymers include polystyrene, polyvinyl chloride, polyamides, polyacrylics, cellulosics, polyesters, and polyhalocarbons. Copolymers of ethylene with propylene, isobutene, butene, hexene, octene, vinyl acetate, vinyl chloride, vinyl propionate, vinyl isobutyrate, vinyl alcohol, allyl alcohol, allyl acetate, allyl acetone, allyl benzene, allyl ether, ethyl acrylate, methyl acrylate, methyl methacrylate, acrylic acid, and methacrylic acid may also be used. Various polymers and resins which find wide application in peroxide-cured or vulcanized rubber articles may also be added, such as polychloroprene, polybutadiene, polyisoprene, poly(isobutylene), nitrile- butadiene rubber, styrene-butadiene rubber, chlorinated polyethylene, chlorosulfonated polyethylene, epichlorohydrin rubber, polyacrylates, butyl or halo-butyl rubbers, or the like, or combinations comprising at least one of the foregoing polymers and resins. Other resins including blends of the above materials may also be added to the polyolefin foams and elastomers.

A preferred polyolefin blend (particularly for use as an elastomer) comprises a single-site initiated polyolefin resin having a density of less than or equal to about 0.878 g-cm⁻³ and less than or equal to about 40 weight percent of a polyolefin comprising ethylene and propylene wherein the weight percents are based upon the total composition. At least a portion of the blend is cross-linked to form an elastomer if desired. The elastomer may be used as a gasket if desired and is generally thermally stable at 48° C. (120° F.). A preferred polyolefin comprising ethylene and propylene is EPR, even more preferably EPDM. The polyolefin blend preferably has greater than or equal to about 5 wt % of the single-site initiated polyolefin resin and greater than or equal to about 5 wt % of the polyolefin that comprises ethylene and propylene.

In addition to the single site initiated polyolefin resin having a density of less than or equal to about 0.878 g-cm⁻³ and the polyolefin comprising ethylene and propylene, the polymer blend may contain less than or equal to about 70 wt % of other polymer resins such as low density polyethylene, high density polyethylene, linear low density polyethylene, polystyrene, polyvinyl chloride, polyamides, polyacrylics, celluloses, polyesters, and polyhalocarbons. Copolymers of ethylene with propylene, isobutene, butene, hexene, octene, vinyl acetate, vinyl chloride, vinyl propionate, vinyl isobutyrate, vinyl alcohol, allyl alcohol, allyl acetate, allyl acetone, allyl benzene, allyl ether, ethyl acrylate, methyl acrylate, methyl methacrylate, acrylic acid, and methacrylic acid may also be used. Various polymers and resins which find wide application in peroxide-cured or vulcanized rubber articles may also be added, such as polychloroprene, polybutadiene, polyisoprene, poly(isobutylene), nitrile- butadiene rubber, styrene-butadiene rubber, chlorinated polyethylene, chlorosulfonated polyethylene, epichlorohydrin rubber, polyacrylates, butyl or halo-butyl rubbers, or the like, or combinations comprising at least foregoing polymer resins.

The polyolefins foams and elastomers may or may not be crosslinked. Cross-linking of polyolefinic materials with any additional polymers such as, for example, those listed above, may be effected through several known methods including: (1) use of free radicals provided through the use of organic peroxides or electron beam irradiation; (2) sulfur cross-linking in standard EPDM (rubber) curing; (3) and moisture curing of silane-grafted materials. The cross-linking methods may be combined in a co-cure system or may be used individually crosslink the elastomeric or foamed compositions. In the case of polyolefinic foams, the cross-linking of the foamed compositions aids in the formation of desirable foams and also leads to the improvement of the ultimate physical properties of the materials. The level of cross-linking in the material may be adjusted to vary the mechanical properties of the foam. The silane-grafting, cross-linking mechanism is particularly advantageous because it provides a change in the polymer rheology by producing a new structure having improved mechanical properties. In one embodiment, crosslinking of the polyolefin foam or elastomer may be achieved through the use of ethylenically unsaturated functionalities grafted onto the chain backbone of the essentially linear polyolefin.

Suitable chemical cross-linking agents include, but are not limited to, organic peroxides, preferably alkyl and aralkyl peroxides. Examples of such peroxides include: dicumylperoxide, 2,5-dimethyl-2,5-di(t-butylperoxy)hexane, 1,1-bis(t-butylperoxy)-3,3,5-trimethylcyclohexane, 1,1-di-(t-butylperoxy)-cyclohexane, 2,2′-bis(t-butylperoxy) diisopropylbenzene, 4,4′-bis(t-butylperoxy) butylvalerate, t-butylperbenzoate, t-butylperterephthalate, and t-butyl peroxide. Most preferably, the cross-linking agent is dicumyl peroxide (Dicup) or 2,2′-bis(t-butylperoxy) diisopropylbenzene (Vulcup).

Chemically cross-linked compositions are improved upon with the addition of multi-functional monomeric species, often referred to as “coagents”. Illustrative, but non-limiting, examples of coagents suitable for use in chemical cross-linking include di- and tri-allyl cyanurates and isocyanurates, alkyl di- and tri-acrylates and methacrylates, zinc-based dimethacrylates and diacrylates, and 1,2-polybutadiene resins.

Preferred agents used in the silane grafting of the polyolefin foams and elastomers are the azido-functional silanes of the general formula RR′SiY₂, in which R represents an azido-functional radical attached to silicon through a silicon-to-carbon bond and composed of carbon, hydrogen, optionally sulfur and oxygen; each Y represents a hydrolyzable organic radical; and R′ represents a monovalent hydrocarbon radical or a hydrolyzable organic radical. Azido-silane compounds are grafted onto an olefinic polymer though a nitrene insertion reaction. Cross-linking develops through hydrolysis of the silanes to silanols followed by condensation of silanols to siloxanes. Certain metal soap catalysts such as dibutyl tin dilaurate or butyl tin maleate and the like catalyze the condensation of silanols to siloxanes. Suitable azido-functional silanes include the trialkoxysilanes such as 2-(trimethoxylsilyl) ethyl phenyl sulfonyl azide and (triethoxysilyl) hexyl sulfonyl azide.

Other suitable silane cross-linking agents include vinyl functional alkoxy silanes such as vinyl trimethoxy silane and vinyl trimethoxy silane. These silane cross-linking agents may be represented by the general formula RR′SiY₂ in which R represents a vinyl functional radical attached to silicon through a silicon-carbon bond and composed of carbon, hydrogen, and optionally oxygen or nitrogen, each Y represents a hydrolyzable organic radical, and R′ represents a hydrocarbon radical or Y. When silane cross-linking agents are used, water is generally added during the processing in order to facilitate cross-linking. It is generally desirable to use a silane-grafted essentially linear olefin copolymer resin having a silane-graft content of less than or equal to about 6 wt % of the total weight of the composition. Within this range, it is generally preferably to have a silane graft content of greater than or equal to about 0.1 wt % of the total weight of the composition. Also desirable within this range is a silane graft content of less than or equal to about 2 wt % of the total weight of the composition. The silane may include a vinyl silane having a C₂ to C₁₀ alkoxy group. It is generally desirable to use a vinyl silane having 2 or 3 hydrolyzable groups, wherein the hydrolyzable groups are C₂-C₁₀ alkoxy groups. Most preferably, the silane includes vinyl triethoxysilane. In foamed polyolefin articles, the silane includes a vinyl silane having a C₁ to C₁₀ alkoxy group.

The expanding medium or blowing agents used to produce polyolefin foams may be normally gaseous, liquid, or solid compounds or elements, or mixtures thereof. In a general sense, these blowing agents may be characterized as either physically expanding or chemically decomposing. Of the physically expanding blowing agents, the term “normally gaseous” is intended to mean that the blowing agent employed is a gas at the temperatures and pressures encountered during the preparation of the foamable compound, and that this medium may be introduced either in the gaseous or liquid state as convenience would dictate.

Included among the normally gaseous and liquid blowing agents are the halogen derivatives of methane and ethane, such as methyl fluoride, methyl chloride, difluoromethane, methylene chloride, perfluoromethane, trichloromethane, difluoro-chloromethane, dichlorofluoromethane, dichlorodifluoromethane (CFC-12), trifluorochloromethane, trichloromonofluoromethane (CFC-11), ethyl fluoride, ethyl chloride, 2,2,2-trifluoro-1,1-dichloroethane (HCFC-123), 1,1,1-trichloroethane, difluorotetrachloroethane, 1,1-dichloro-1-fluoroethane (HCFC-141b), 1,1-difluoro-1-chloroethane (HCFC-142b), dichlorotetrafluoroethane (CFC-114), chlorotrifluoroethane, trichlorotrifluoroethane (CFC-113), 1-chloro-1,2,2,2-tetrafluoroethane (HCFC-124), 1,1-difluoroethane (HFC-152a), 1,1,1-trifluoroethane (HFC-143a), 1,1,1,2-tetrafluoroethane (HFC-134a), perfluoroethane, pentafluoroethane, 2,2-difluoropropane, 1,1,1-trifluoropropane, perfluoropropane, dichloropropane, difluoropropane, chloroheptafluoropropane, dichlorohexafluoropropane, perfluorobutane, perfluorocyclobutane, sulfur-hexafluoride, and mixtures thereof. Other normally gaseous and liquid blowing agents that may be employed are hydrocarbons and other organic compounds such as acetylene, ammonia, butadiene, butane, butene, isobutane, isobutylene, dimethylamine, propane, dimethylpropane, ethane, ethylamine, methane, monomethylamine, trimethylamine, pentane, cyclopentane, hexane, propane, propylene, alcohols, ethers, ketones, and the like. Inert gases and compounds, such as carbon dioxide, nitrogen, argon, neon, or helium, may be used as blowing agents with satisfactory results. A physical blowing agent may be used to produce foam directly out of the extrusion die. The composition may optionally include chemical foaming agents for further expansion.

Solid, chemically decomposable foaming agents, which decompose at elevated temperatures to form gasses, may be used. In general, the decomposable foaming agent will have a decomposition temperature (with the resulting liberation of gaseous material) of about 130° C. to about 350° C. Representative chemical foaming agents include azodicarbonamide, p,p′-oxybis (benzene) sulfonyl hydrazide, p-toluene sulfonyl hydrazide, p-toluene sulfonyl semicarbazide, 5-phenyltetrazole, ethyl-5-phenyltetrazole, dinitroso pentamethylenetetramine, and other azo, N-nitroso, carbonate and sulfonyl hydrazides as well as various acid/bicarbonate compounds which decompose when heated.

In the-production of electrically conductive polyolefin foams, the polyolefin resins, carbon nanotubes, physical blowing agents, crosslinking agents, initiators and other desired additives are fed into an extruder. Alternatively, it may be possible for the blowing agents such as liquid carbon dioxide or supercritical carbon dioxide to be pumped into the extruder further downstream. When physical blowing agents are pumped into extruder it is desirable for the melt in the extruder to be maintained at a certain pressure and temperature, to facilitate the solubility of the blowing agent into the melt, and also to prevent foaming of the melt within the extruder. The carbon nanotubes may also be added to the extruder further downstream either directly or in masterbatch form. The extrudate upon emerging from the mixer will start to foam. The density of the foam is dependent upon the solubility of the physical blowing agent within the melt, as well as the pressure and temperature differential between the extruder and the outside. If solid-state chemical blowing agents are used, then the foam density will depend upon the amount of the chemical blowing agents used. In order to effect complete blowing of the polyolefin foam, the extrudate may be further processed in high temperature ovens where radio frequency heating, microwave heating, and convectional heating may be combined.

In the production of thermosetting electrically conductive polyolefin foams, it is generally desirable to first crosslink the composition, prior to subjecting it to foaming at higher temperatures. The foaming at higher temperatures may be accomplished by radio frequency heating, microwave heating, convectional heating, or a combination comprising at least one of the foregoing methods of heating.

In the production of electrically conductive polyolefin elastomers, the above-described components (with the exception of the blowing agents) are generally added to a mixing device such as a Banbury, a roll mill or and extruder in order to intimately mix the components. Curing of the polyolefin elastomer may begin during the mixing process and may continue after the mixing is completed. In certain instances, it may be desirable to subject the elastomer to a post-curing step after the mixing. Post-curing may be accomplished in a separate convectional oven or may be carried out online using convectional ovens and electromagnetic heating (e.g., radio frequency heating, microwave heating, or the like).

Preferably, the electrically conductive polyolefin foams have mechanical properties similar to those of the same polyolefin foam without carbon nanotubes. Desirable properties include a density of about 1 to about 20 pcf, a 25% CFD of about 0.25 to about 40 psi, an elongation to break of greater than or equal to about 50%, and a compression set of less than or equal to about 70%.

The electrically conductive polyolefin elastomers preferably have mechanical properties that are the same as, or similar to the same polyolefin elastomer without carbon nanotubes. Desirable properties for a polyolefin elastomer include a Shore A durometer of less than or equal to about 80, preferably less than or equal to about 40, and an elongation to break of greater than or equal to about 50%.

Silicone foams and elastomers comprising a polysiloxane polymer and carbon nanotubes may also be advantageously utilized to provide electrically conductive compositions, particularly electromagnetic shielding and/or electrostatically dissipative.

The silicone foams are generally produced as a result of the reaction between water and hydride groups on the polysiloxane polymer with the consequent liberation of hydrogen gas. This reaction is generally catalyzed by a noble metal, preferably a platinum catalyst. The polysiloxane polymer used in the foams or the elastomers generally has a viscosity of about 100 to 1,000,000 poise at 25° C. and has chain substituents selected from the group consisting of hydride, methyl, ethyl, propyl, vinyl, phenyl, and trifluoropropyl. The end groups on the polysiloxane polymer may be hydride, hydroxyl, vinyl, vinyl diorganosiloxy, alkoxy, acyloxy, allyl, oxime, aminoxy, isopropenoxy, epoxy, mercapto groups, or other known, reactive end groups. Suitable silicone foams may also be produced by using several polysiloxane polymers, each having different molecular weights (e.g., bimodal or trimodal molecular weight distributions) as long as the viscosity of the combination lies within the above specified values. It is also possible to have several polysiloxane base polymers with different functional or reactive groups in order to produce the desired foam. It is generally desirable to have about 0.2 moles of hydride (Si—H) groups per mole of water.

Depending upon the chemistry of the polysiloxane polymers used, a catalyst, generally platinum or a platinum-containing catalyst, may be used to catalyze the blowing and the curing reaction. The catalyst may be deposited onto an inert carrier, such as silica gel, alumina, or carbon black. Preferably, an unsupported catalyst selected from among chloroplatinic acid, its hexahydrate form, its alkali metal salts, and its complexes with organic derivatives is used. Particularly recommended are the reaction products of chloroplatinic acid with vinylpolysiloxanes such as 1,3-divinyltetramethyldisiloxane, which are treated or otherwise with an alkaline agent to partly or completely remove the chlorine atoms as described in U.S. Pat. Nos. 3,419,593; 3,775,452 and 3,814,730; the reaction products of chloroplatinic acid with alcohols, ethers, and aldehydes as described in U.S. Pat. No. 3,220,972; and platinum chelates and platinous chloride complexes with phosphines, phosphine oxides, and with olefins such as ethylene, propylene, and styrene as described in U.S. Pat. Nos. 3,159,601 and 3,552,327. It may also be desirable, depending upon the chemistry of the polysiloxane polymers to use other catalysts such as dibutyl tin dilaurate in lieu of platinum based catalysts.

Various platinum catalyst inhibitors may also be used to control the kinetics of the blowing and curing reactions in order to control the porosity and density of the silicone foams. Common examples of such inhibitors are polymethylvinylsiloxane cyclic compounds and acetylenic alcohols. These inhibitors should not interfere with the foaming and curing in such a manner that destroys the foam.

Physical or chemical blowing agents may be used to produce the silicone foam, including the physical and chemical blowing agents listed above for polyurethanes or polyolefins. Under certain circumstances it may be desirable to use a combination of methods of blowing to obtain foams having desirable characteristics. For example, a physical blowing agent such as a chlorofluorocarbon may be added as a secondary blowing agent to a reactive mixture wherein the primary mode of blowing is the hydrogen released as the result of the reaction between water and hydride substituents on the polysiloxane.

In the production of silicone foams, the reactive components are generally stored in two packages, one containing the platinum catalyst and the other the polysiloxane polymer containing hydride groups, which prevents premature reaction. It is possible to include the nanotubes in either package. In another method of production, the polysiloxane polymer may introduced into an extruder along with the carbon nanotubes, water, physical blowing agents if necessary and other desirable additives. The platinum catalyst is then metered into the extruder to start the foaming and curing reaction. The use of physical blowing agents such as liquid carbon dioxide or supercritical carbon dioxide in conjunction with chemical blowing agents such as water may give rise to foam having much lower densities. In yet another method, the liquid silicone components are metered, mixed and dispensed into a device such a mold or a continuous coating line. The foaming then occurs either in the mold or on the continuous coating line.

Preferably, the electrically conductive silicone foams have mechanical properties that are the same or similar to those of the same silicone foams without the carbon nanotubes. Desirable properties include a density of about 1 to about 40 pcf, a 25% CFD of about 0.1 to about 80 psi, an elongation to break of about greater than 20% and a compression set of less than about 15%.

A soft, electrically conductive silicone elastomer may be formed by the reaction of a liquid silicone composition comprising a polysiloxane having at least two alkenyl groups per molecule; a polysiloxane having at least two silicon-bonded hydrogen atoms in a quantity effective to cure the composition; a catalyst, carbon nanotubes; and optionally a reactive or non-reactive polysiloxane fluid having a viscosity of about 100 to about 1000 centipoise. Suitable reactive silicone compositions are low durometer, 1:1 liquid silicone rubber (LSR) or liquid injection molded (LIM) compositions. Because of their low inherent viscosity, the use of the low durometer LSR or LIM facilitates the addition of higher filler quantities, and results in formation of a low durometer elastomer or foam.

The reactive or non-reactive polysiloxane fluid allows higher quantities of filler to be incorporated into the cured silicone composition, thus lowering the obtained volume and surface resistivity values. It is generally desirable for the polysiloxane fluid to remain within the cured silicone and not to be extracted or removed. The reactive silicone fluid thus becomes part of the polymer matrix, leading to low outgassing and little or no migration to the surface during use. The boiling point of the non-reactive silicone fluid is preferably high enough such that when it is dispersed in the polymer matrix, it does not evaporate during or after cure, and does not migrate to the surface or outgas.

LSR or LIM systems are generally provided as two-part formulations suitable for mixing in ratios of about 1:1 by volume. The “A” part of the formulation generally contains one or more polysiloxanes having at least two alkenyl groups and has an extrusion rate of less than about 500 g/minute. Suitable alkenyl groups are exemplified by vinyl, allyl, butenyl, pentenyl, hexenyl, and heptenyl, with vinyl being particularly preferred. The alkenyl group can be bonded at the molecular chain terminals, in pendant positions on the molecular chain, or both. Other silicon-bonded organic groups in the polysiloxane having at least two alkenyl groups are exemplified by substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Methyl and phenyl are specifically preferred.

The alkenyl-containing polysiloxane can have straight chain, partially branched straight chain, branched-chain, or network molecule structure, or may be a mixture of two or more selections from polysiloxanes with the exemplified molecular structures. The alkenyl-containing polysiloxane is exemplified by trimethylsiloxy-endblocked dimethylsiloxane-methylvinylsiloxane copolymers, trimethylsiloxy-endblocked methylvinylsiloxane-methylphenylsiloxane copolymers, trimethylsiloxy-end blocked dimethylsiloxane-methylvinylsiloxane-methylphenylsiloxane copolymers, dimethylvinylsiloxy-endblocked dimethylpolysiloxanes, dimethylvinylsiloxy-endblocked methylvinylpolysiloxanes, dimethylvinylsiloxy-endblocked methylvinylphenylsiloxanes, dimethylvinylsiloxy-endblocked dimethylvinylsiloxane-methylvinylsiloxane copolymers, dimethylvinylsiloxy-endblocked dimethylsiloxane-methylphenylsiloxane copolymers, dimethylvinylsiloxy-endblocked dimethylsiloxane-diphenylsiloxane copolymers, polysiloxane comprising R₃SiO_{1/2} and SiO_{4/2} units, polysiloxane comprising RSiO_{3/2} units, polysiloxane comprising the R₂SiO_{2/2} and RSiO_{3/2} units, polysiloxane comprising the R₂SiO_{2/2}, RSiO_{3/2} and SiO_{4/2} units, and a mixture of two or more of the preceding polysiloxanes. R represents substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl, with the proviso that at least 2 of the R groups per molecule are alkenyl.

The B component of the LSR or LIM system generally contains one or more polysiloxanes that contain at least two silicon-bonded hydrogen atoms per molecule and has an extrusion rate of less than about 500 g/minute. The hydrogen can be bonded at the molecular chain terminals, in pendant positions on the molecular chain, or both. Other silicon-bonded groups are organic groups exemplified by non-alkenyl, substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Methyl and phenyl are specifically preferred.

The hydrogen-containing polysiloxane component can have straight-chain, partially branched straight-chain, branched-chain, cyclic, network molecular structure, or may be a mixture of two or more selections from polysiloxanes with the exemplified molecular structures. The hydrogen-containing polysiloxane is exemplified by trimethylsiloxy-endblocked methylhydrogenpolysiloxanes, trimethylsiloxy-endblocked dimethylsiloxane-methylhydrogensiloxane copolymers, trimethylsiloxy-endblocked methylhydrogensiloxane-methylphenylsiloxane copolymers, trimethylsiloxy-endblocked dimethylsiloxane-methylhydrogensiloxane-methylphenylsiloxane copolymers, dimethylhydrogensiloxy-endblocked dimethylpolysiloxanes, dimethylhydrogensiloxy-endblocked methylhydrogenpolysiloxanes, dimethylhydrogensiloxy-endblocked dimethylsiloxanes-methylhydrogensiloxane copolymers, dimethylhydrogensiloxy-endblocked dimethylsiloxane-methylphenylsiloxane copolymers, and dimethylhydrogensiloxy-endblocked methylphenylpolysiloxanes.

The hydrogen-containing polysiloxane component is added in an amount sufficient to cure the composition, preferably in a quantity of about 0.5 to about 10 silicon-bonded hydrogen atoms per alkenyl group in the alkenyl-containing polysiloxane.

The silicone composition further comprises, generally as part of Component B. a catalyst such as platinum to accelerate the cure. Platinum and platinum compounds known as hydrosilylation-reaction catalysts can be used, for example platinum black, platinum-on-alumina powder, platinum-on-silica powder, platinum-on-carbon powder, chloroplatinic acid, alcohol solutions of chloroplatinic acid platinum-olefin complexes, platinum-alkenylsiloxane complexes and the catalysts afforded by the microparticulation of the dispersion of a platinum addition-reaction catalyst, as described above, in a thermoplastic resin such as methyl methacrylate, polycarbonate, polystyrene, silicone, and the like. Mixtures of catalysts may also be used. An quantity of catalyst effective to cure the present composition is generally from 0.1 to 1,000 parts per million (by weight) of platinum metal based on the combined amounts of alkenyl and hydrogen components.

The composition optionally further comprises one or more polysiloxane fluids having a viscosity of less than or equal to about 1000 centipoise, preferably less than or equal to about 750 centipoise, more preferably less than or equal to about 600 centipoise, and most preferably less than or equal to about 500 centipoise. The polysiloxane fluids may also have a have a viscosity of greater than or equal to about 100 centipoises. The polysiloxane fluid component is added for the purpose of decreasing the viscosity of the composition, thereby allowing at least one of increased filler loading, enhanced filler wetting, and enhanced filler distribution, and resulting in cured compositions having lower resistance and resistivity values. Use of the polysiloxane fluid component may also reduce the dependence of the resistance value on temperature, and/or reduce the timewise variations in the resistance and resistivity values. Use of the polysiloxane fluid component obviates the need for an extra step during processing to remove the fluid, as well as possible outgassing and migration of diluent during use. The polysiloxane fluid should not inhibit the curing reaction, i.e., the addition reaction, of the composition but it may or may not participate in the curing reaction.

The non-reactive polysiloxane fluid has a boiling point of greater than about 500° F. (260° C.), and may be branched or straight-chained. The non-reactive polysiloxane fluid comprises silicon-bonded non-alkenyl organic groups exemplified by substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Methyl and phenyl are specifically preferred. Thus, the non-reactive polysiloxane fluid may comprise R₃SiO_{1/2} and SiO_{4/2} units, RSiO_{3/2} units, R₂SiO_{2/2} and RSiO_{3/2} units, or R₂SiO_{2/2}, RSiO_{3/2} and SiO_{4/2} units, wherein R represents substituted and unsubstituted monovalent hydrocarbon groups selected from the group consisting of alkyl, methyl, ethyl, propyl, butyl, pentyl, hexyl, aryl, phenyl, tolyl, xylyl, aralkyl, benzyl, phenethyl, halogenated alkyl, 3-chloropropyl, and 3,3,3-trifluoropropyl. Because the non-reactive polysiloxane is a fluid and has a significantly higher boiling point (greater than about 230° C. (500° F.)), it allows the incorporation of higher quantities of filler, but does not migrate or outgas. Examples of non-reactive polysiloxane fluids include DC 200 from Dow Corning Corporation.

Reactive polysiloxane fluids co-cure with the alkenyl-containing polysiloxane and the polysiloxane having at least two silicon-bonded hydrogen atoms, and therefore may themselves contain alkenyl groups or silicon-bonded hydrogen groups. Such compounds may have the same structures as described above in connection with the alkenyl-containing polysiloxane and the polysiloxane having at least two silicon-bonded hydrogen atoms, but in addition have a viscosity of less than or equal to about 1000 centipoise (cps), preferably less than or equal to about 750 cps, more preferably less than or equal to about 600 cps, and most preferably less than or equal to about 500 cps. The reactive polysiloxane fluids preferably have a boiling point greater than the curing temperature of the addition cure reaction.

The polysiloxane fluid component is present in amount effective to allow the addition, incorporation, and wetting of higher quantities of conductive filler and/or to facilitate incorporation of the carbon nanotubes, for example to facilitate detangling and/or dispersion. Such quantities are readily determined by one of ordinary skill in the art. In general, the polysiloxane fluid component is added to the composition in an amount of about 5 to about 50 weight parts per 100 weight parts of the combined amount of the polysiloxane having at least two alkenyl groups per molecule, the polysiloxane having at least two silicon-bonded hydrogen atoms in a quantity effective to cure the composition, the catalyst, and the filler. The amount of the polysiloxane fluid component is preferably greater than or equal to about 5, more preferably greater than or equal to about 7.5, and even more preferably greater than or equal to about 10 weight parts. Also desired is a polysiloxane fluid component of less than or equal to about 50 weight parts, more preferably less than or equal to about 25 weight parts, and more preferably less than or equal to about 20 weight parts.

The silicone elastomers may further optionally comprise a curable silicon gel formulation. Silicone gels are lightly cross-linked fluids or under-cured elastomers. They are unique in that they range from very soft and tacky to moderately soft and only slightly sticky to the touch. Use of a gel formulation decreases the viscosity of the composition adversely, thereby allowing at least one of an increased filler loading, enhanced filler wetting, and enhanced filler distribution, thereby resulting in cured compositions having lower resistance and resistivity values and increased softness. Suitable gel formulations may be either two-part curable formulations or one-part formulations. The components of the two-part curable gel formulations is similar to that described above for LSR systems (i.e., an organopolysiloxane having at least two alkenyl groups per molecule and an organopolysiloxane having at least two silicon-bonded hydrogen atoms per molecule). The main difference lies in the fact that no filler is present, and that the molar ratio of the silicon bonded hydrogen groups (Si—H) groups to the alkenyl groups is usually less than one, and can be varied to create a “under-cross linked” polymer with the looseness and softness of a cured gel. Preferably, the ratio of silicone-bonded hydrogen atoms to alkenyl groups is less than or equal to about 1.0, preferably less than or equal to about 0.75, more preferably less than or equal to about 0.6, and most preferably less than or equal to about 0.1. An example of a suitable two-part silicone gel formulation is SYLGARD® 527 gel commercially available from the Dow Corning Corporation.

A preferred method for preparing the silicone elastomer from the compositions described above is mixing the different components to homogeneity and removal of air by degassing under vacuum. The composition is then poured onto a release liner and cured by holding the composition at room temperature (e.g., 25° C.), or by heating. When a non-reactive polysiloxane fluid is present, cure is at a temperature below the boiling point of the fluid so as to substantially prevent removal of the fluid during cure. Preferably, cure temperatures are at least about 20° C., preferably at least about 50° C., most preferably at least about 80° C. below the boiling point of the fluid component. When using reactive fluid, the cure temperature is such that the fluid cures before it can be driven off.

In a preferred continuous method for the preparation of the silicone elastomers, the appropriate amounts of each component is weighed into a mixing vessel, such as, for example, a Ross mixer, followed by mixing under vacuum until homogeneity is achieved. The mixture is then transferred onto a moving carrier. Another layer of carrier film is then pulled though on top of the mixture and the sandwiched mixture is then pulled through a coater, which determines the thickness of the final elastomer. The composition is then cured, followed by an optional post-cure.

The elastomeric silicones are particularly suitable for continuous manufacture in a roll form by casting, which allows the production of continuous rolls in sheet form at varying thicknesses, with better thickness tolerances. The present compositions may be used to make sheets having a cross-section less than 6.3 mm (0.250 inches), preferably in very thin cross sections such as about 0.005 to about 0.1 inches, which is useful, for example, in electronic applications.

Preferably, the electrically conductive silicone elastomers have mechanical properties similar to those of the same silicone elastomers without carbon nanotubes. Desirable properties include a Shore A Hardness of less than or equal to about 30, compression set of less than or equal to about 30, and an elongation of greater than or equal to about 20%.

Use of carbon nanotubes unexpectedly allows the manufacture of polymeric foams and elastomers that have excellent electrical conductivity and physical properties, particularly compression set and/or softness. These characteristics permit the polymeric foams and elastomers to be used as a variety of articles such as gasketing materials, particularly where electromagnetic and/or electrostatic dissipative properties are desired. The articles are suitable for use in a variety of commercial applications such as cell phones, personal digital assistants, computers, airplanes and other articles of commerce where hitherto only metal sheets and metallized meshes would be used.

The following examples, which are meant to be exemplary, not limiting, illustrate compositions and methods of manufacturing of some of the various embodiments of the electromagnetically shielding and/or electrostatically dissipative and/or electrically conductive elastomers and polymeric foams described herein.

### EXAMPLES

Compression set was determined by measuring amount in percent by which a standard test piece of the elastomer or foam fails to return to its original thickness after being subjected to 50% compression for 22 hours at the specified temperature.

Modulus as reflected by compression force deflection (CFD) was determined on an Instron using 5×5 centimeter die-cut samples stacked to a minimum of 0.6 centimeters (0.250 inches), usually about 0.9 centimeters (0.375 inches), using two stacks per lot or run, and a 9090 kg (20,000 pound) cell mounted in the bottom of the Instron. CFD was measured by calculating the force in pounds per square inch (psi) required to compress the sample to 25% of the original thickness.

Tensile strength and elongation were measured using an Instron fitted with a 20 kilogram (50-pound) load cell and using 4.5-9.0 kilogram range depending on thickness and density. Tensile strength is calculated as the amount of force in kilogram per square centimeter (kg/cm²) at the break divided by the sample thickness and multiplied by two. Elongation is reported as percent extension.

Tear strength was measured using an Instron fitted with a 20 kilogram load cell and using a 0.9, 2.2, or 4.5 kilogram load range depending on sample thickness and density. Tear strength is calculated by dividing the force applied at tear by the thickness of the sample.

As is known, particular values for volume resistivity and electrostatic shielding will depend on the particular test methods and conditions. For example, it is known that volume resistivity and shielding effectiveness may vary with the pressure placed on the sample during the test. The electrical equipment and test fixtures used to measure volume resistivity in the sample below are as follows. The fixture is a custom fabricated press with gold plated, 2.5 cm×2.5 cm (1 inch×1 inch) square, and electrical contacts. The fixture is equipped with a digital force gauge that allows the operator to control and make adjustments to the force that is applied to the surface of the sample. The Power supply is capable of supplying 0 to 2 amps to the sample surface. The Voltage drop and ohms across the sample are measured using a HP 34420A Nano Volt/Micro Ohmmeter. The electronic components of the fixture are allowed to warm up and, in the case of the HP 34420 A, the internal calibration checks are done. The samples are allowed to equilibrate, for a period of 24 hours, to the conditions of the test environment. Typical test environment is 50% Relative Humidity (% RH) with a room temp of 23° C. (70° F.). The sample to be tested is placed between the platens of the test fixture and a load is applied to the surface. The applied load is dependent on the type of sample to be tested, soft elastomers are tested using small loads while solids are tested using a load range from about 63,279 to about 210,930 kg/square meter (90 to 300 pounds per square inch). Once the load has been applied, the current is applied to the sample and the voltage drop through the sample thickness is measured. A typical test would include measurements at 4 different amp settings, 0.5, 1.0, 1.6, and 2.0 amps. For a conductive composite the resulting calculated volume resistivity for all four of the amp settings will be similar. The calculation for the volume resistivity is as follows:

Volume resistivity (ohm-cm)=(E/I)*(A/T)

wherein E=voltage drop (V), I=current (amps), A=area (cm²), and T=thickness (cm).

Volume resistivity measurements were similarly made on elastomeric samples by cutting a rectangular sample, coating the ends with silver paint, permitting the paint to dry and using a voltmeter to make resistance measurements.

Use of carbon nanotubes enables the production of electrically conductive polymeric foams having a volume resistivity of about 10⁻³ ohm-cm to about 10⁸ ohm-cm, and preferably less than or equal to about 10⁶, less than or equal to about 10⁴, or less than or equal to about 10³ , and more preferably less than or equal to about 10², less than or equal to about 10, and most preferably less than or equal to about 1 ohm-cm, as measured by the above-described method. Use of carbon nanotubes also allows the production of electrically conductive elastomers having a volume resistivity of about 10⁻³ ohm-cm to about 10³ ohm-cm, preferably less than or equal to about 10² ohm-cm, more preferably less than or equal to about 10, and most preferably less than or equal to about 1 ohm-cm.

In the Tables, all component amounts are in parts by weight.

### Example 1.

Chemicals, sources, and descriptions are listed in Table 1 below.

TABLE 1

| Trade Name | Source | Description |
|---|---|---|
| E351 | Bayer | Ethylene oxide capped polypropylene |
| | | oxide diol, MW = 2800 |
| 1652 | Bayer | Polypropylene oxide triol, MW = |
| | | 3000 |
| PPG 1025 | Bayer | Polypropylene oxide diol, MW = |
| | | 1000 |
| PPG 2000 | Bayer | Polypropylene oxide diol, MW = |
| | | 2000 |
| MPDiol | Bayer | 2-Methyl-1,3-propane diol (chain |
| | | extender) |
| MPTD | Kuraray | 3-Methyl-1,5-pentane diol (chain |
| | | extender) |
| Niax 24-32 | Bayer | Polypropylene oxide diol with poly- |
| | | styrene and polyacrylonitrile grafts, |
| | | MW = 2800 |
| TONE 0201 | Union Carbide | Polycaprolactone-based polyester |
| | | diol, MW = 500 |
| DPG | — | Dipropylene glycol (diol chain |
| | | extender) |
| NIAX 34-35 | Bayer | Polypropylene oxide triol with poly- |
| | | styrene and polyacrylonitrile grafts, |
| | | MW = 3000 (polymer polyol) |
| L-5617 | Crompton/Osi | Silicone-based surfactant |
| Alumina | — | Aluminum trihydrate (flame retardant |
| | | filler) |
| 3A Sieves | — | Alkali metal alumino silicate, |
| | | K₁₂[(AlO₂)₁₂(SiO₂)₁₂]XH₂O |
| | | (water absorption) |
| IRGANOX | Ciba | Hindered phenol (antioxidant) |
| 1135 | | |
| IRGANOX | Ciba | Aromatic amine (antioxidant) |
| 5057 | | |
| Pigment | PAN Chemical | Colorant, in 34-45 polyol |
| Catalyst | — | Ferric acetyl acetonate and acetyl |
| | | acetone in polyol |
| BAYTUFT 751 | Bayer | Polymeric diphenyl methane |
| | | diisocyanate, % NCO = 27.6, |
| | | Average Functionality = 2.2 |
| Carbon | Nanostructured | Electrically conductive filler |
| Nanotubes | and Amorphous | |
| | materials | |

For each elastomer or foam, all components except for the isocyanate are mixed and placed in a holding tank with agitation and under dry nitrogen in the amounts shown in Table 2 below. This mixture is then pumped at a controlled flow rate to a high shear mixing head of the Oakes type. The isocyanate mixture is also separately pumped into the mixing head at controlled flow rates and at the proper flow ratios relative to the polyols mixture flow rate. Flow meters are used to measure and adjust the flow rates of the various raw material streams. After mixing in the high shear mixer, the materials are pumped through flexible hoses and out through rigid nozzles. The elastomer or foam is then cast onto coated release paper that had been dried just prior to the point where the elastomer or foam is introduced. This prevented any water that might have been in the paper from participating in the reaction. The release paper is about 13 inches wide and is drawn through the machine at a controlled speed (about 10 feet per minute). The paper and cast elastomer or foam then passes under a knife over plate coater to spread the elastomer or foam and to control the thickness of the final product.

The coated release paper is then passed through a curing section consisting of heated platens kept at 123° C. (250° F.) to 195° C. (375° F.) by a series of thermocouples, controllers and heating elements. A series of upper platens is kept at 232° C. (450° F.). The cured product is then passed through an air-cooling section, a series of drive rollers and is wound up on a take-up roll.

TABLE 2

| Component | Sample Number | | | | |
|---|---|---|---|---|---|
| Polyol Side | 1 | 2 | 3 | 4 | 5 |
| E351 | 23.93 | | | | |
| 1652 | | | | | 36.69 |
| PPG 1025 | | | | | 12.8 |
| PPG 2025/PPG 2000 | 36.3 | | 28.67 | 27.4 | |
| MPDiol | | | | | 1.9 |
| MPTD | | | | | 11.25 |
| Niax 24-32 | | 40.82 | | | |
| TONE 0201 | 10.8 | 10.8 | 10.8 | 10.8 | 10.8 |
| DPG | | | 7.5 | 10.8 | |
| Catalyst | 3.33 | 3.33 | 3.33 | 3.33 | 3.33 |
| NIAX 34-45 | 2.9 | 18.16 | 25 | 22.8 | |
| L-5617 | 2.7 | 2.7 | 2.7 | 2.7 | 2.7 |
| Alumina | 20.1 | 20.1 | 20.1 | 20.1 | 20.1 |
| 3A Sieve | 2 | 2 | 2 | 2 | 2 |
| IRGANOX 1135 | 0.12 | 0.12 | 0.12 | 0.12 | 0.12 |
| IRGANOX 5057 | 0.03 | 0.03 | 0.03 | 0.03 | 0.03 |
| E351 | 23.93 | | | | |
| 1652 | | | | | 36.69 |
| PPG 1025 | | | | | 12.8 |
| PPG 2025/PPG 2000 | 36.3 | | 28.67 | 27.4 | |
| MPDiol | | | | | 1.9 |
| MPTD | | | | | 11.25 |
| Niax 24-32 | | 40.82 | | | |
| TONE 0201 | 10.8 | 10.8 | 10.8 | 10.8 | 10.8 |
| DPG | | | 7.5 | 10.8 | |
| Catalyst | 3.33 | 3.33 | 3.33 | 3.33 | 3.33 |
| Pigment | 6.78 | 9.54 | 9.54 | 9.88 | 9.91 |
| Carbon nanotubes | 5 | 5 | 5 | 5 | 5 |
| Isocyanate | | | | | |
| 751A | 16.33 | 27.6 | 32.67 | 39.74 | 52.62 |

Exemplary properties for the above and other electrically conductive polyurethane foams, particularly electromagnetically shielding and/or electrostatically dissipative foams, are shown in the Table 3 below.

TABLE 3

| | Polyurethane Foams | | |
|---|---|---|---|
| Property | Embodiment 1 | Embodiment 2 | Embodiment 3 |
| Density (pcf) | 1-50 | 8-40 | 12-30 |
| 25% CFD (psi) | 0.1-150 | 0.5-140 | 0.75-130 |
| Elongation (%) | ≧20 | ≧20 | ≧20 |
| Compression Set (%) | ≦30 | ≦20 | ≦10 |
| per ASTM 3574 | | | |
| Tear Strength (pli) | >1 | >1 | >1 |
| Tensile Strength (psi) | >30 | >30 | >30 |

Exemplary properties for the above and other electrically conductive polyurethane elastomers, particularly electromagnetically shielding and/or electrostatically dissipative elastomers, are set forth in Table 4 below:

TABLE 4

| | Polyurethane Elastomers | | |
|---|---|---|---|
| Property | Embodiment 1 | Embodiment 2 | Embodiment 3 |
| Elongation (%) | ≧50 | ≧50 | ≧50 |
| Shore A durometer | ≦80 | ≦60 | ≦40 |
| Compression Set (%) | ≦30 | ≦30 | ≦30 |
| per ASTM D395B | | | |
| Tensile Strength (psi) | ≧30 | ≧30 | ≧30 |

### Example 2

This example demonstrates the electrical properties of polyolefin foams and elastomers. Table 5 shows chemicals, sources, and descriptions suitable for the formation of thermoformable polyolefin foams and elastomers.

TABLE 5

| Trade Name | Source | Description |
|---|---|---|
| Exact 4041 | Exxon | Essentially linear polyolefin |
| | | copolymer having a density of |
| | | 0.878 g/cm³; Comonomer |
| | | type is 1-butene. |
| DPDA 6182 | Union Carbide | Polyethylene/ethyl acrylate |
| | | having 15% ethyl acrylate |
| | | content; Density = 0.93 g/cm³ |
| CV4917 | Huls America Inc. | Vinyl trimethoxy silane |
| Vulcup R | Hercules Chem. | 2,2′-(tert butyl peroxy)diiso- |
| | | propylbenzene |
| DFDA 1173-NT | Union Carbide | 1% dibutyl tin dilaurate |
| | | concentrate in LDPE |
| Azodicarbonamide | Bayer Chemical | 40% concentrate of Bayer |
| | | ADC/F azodicarbonamide in |
| | | EEA 6182 |
| Zinc Stearate | | Zinc stearate, 30% zinc oxide |
| | | concentrate in high pressure |
| | | low density polyethylene |
| | | LDPE |
| Titanium dioxide | | White color concentrate, 50% |
| | | titanium dioxide in high- |
| | | pressure LDPE |
| Carbon nanotubes | Nanostructured | Electrically conductive filler |
| | and Amorphous | |
| | Materials Inc | |

A silane-grafted composition, consisting primarily of an essentially linear polyolefin copolymer along with polyethylene/ethyl acrylate (EEA) as a softener, is prepared at the rate of about 13.6 kilogram/hour (30 lb/hr) using a 60 mm diameter, single-screw extruder having an aspect ratio of 24 and maintained at approximately 200° C. A mixture of organic peroxide and vinyltrimethoxysilane (VTMOS) is metered directly into the feed throat of the extruder. The grafted composition is passed out of a multi-strand die head through a water-cooling trough, and chopped into pellets with a granulator. The composition of the pellets is shown in Table 6.

TABLE 6

| Component | Wt % |
|---|---|
| Exact 4041 | 86 |
| DPDA 6182 | 10 |
| CV4917 | 0.6 |
| Vulcup-R | 0.4 |
| Carbon Nanotubes | 3 |

The pellicular grafted composition is admixed with additional pellicular components in a 19 liter (5 gallon) drum tumbler, metered into a 6.35 cm (2.5-inch diameter), single-screw extruder having an aspect ratio of 24, maintained at approximately 125° C. and fitted with a 35 cm (14-inch) wide coat-hanger die head, and passed through a 60 cm (24-inch) wide three-roll stack to form an unexpanded sheet, 22.5 cm (9 inches) wide and 0.175 cm (0.069 inches) thick, of the composition shown in Table 7.

TABLE 7

| Components | Wt % |
|---|---|
| Exact 4041/DPDA 6182 | 78.9 |
| DFDA-1173 NT | 3.3 |
| Bayer ADC/F azodicarbonamide in EEA-6182 | 11.6 |
| Zinc stearate, 30% zinc oxide concentrate | 3.9 |
| White color concentrate | 2.3 |

The sheet is exposed to 87° C. (190° F.) and 95% relative humidity for 80 minutes to effect the silanolysis cross-linking. A portion of the sheet is retained for testing as an elastomer, while the remaining portion of the sheet is subjected to foaming by passing through a thermostatically-controlled foaming oven with infrared heaters to maintain a surface temperature of 354° C. (670° F.), but with supplementary makeup air at 387° C. (730° F.), whereupon the cross-linked composition expands into a foam having a width of 50.8 centimeters (20 inches) and a thickness of about 0.38 centimeters (0.150 inches). The resulting density of the foam is 6 pcf.

Exemplary physical properties for the above and other electrically conductive polyolefin foams, particularly electromagnetically shielding and/or electrostatically dissipative foams, are set forth in the Table 8 below.

TABLE 8

| | Polyolefin Foams | | |
|---|---|---|---|
| Property | Embodiment 1 | Embodiment 2 | Embodiment 3 |
| Density (pcf) | 1-20 | 1-20 | 2-18 |
| 25% CFD (psi) | 0.25-40 | 1.0-38 | 3-35 |
| Elongation (%) | ≧50 | ≧50 | ≧50 |
| Compression Set (%) | <70 | <50 | <30 |
| (ASTM D1056) | | | |
| Tear (pli) | ≧5 | ≧5 | ≧5 |
| Tensile Strength (psi) | ≧30 | ≧30 | ≧30 |

Exemplary physical properties for the above and other electrically conductive polyolefin elastomers, particularly electromagnetically shielding and/or electrostatically dissipative elastomers, are set forth in Table 9 below.

TABLE 9

| | Polyolefin Elastomers | | |
|---|---|---|---|
| Property | Embodiment 1 | Embodiment 2 | Embodiment 3 |
| Elongation % | ≧50 | ≧50 | ≧50 |
| Shore A durometer | ≦80 | ≦60 | ≦40 |
| Compression Set (%) | ≦70 | ≦70 | ≦70 |
| per ASTM D395B | | | |
| Tensile Strength (^{psi}) | ≧30 | ≧30 | ≧30 |

### Example 3

The following formulations demonstrate conductive silicone elastomers and foams. Table 10 shows chemicals, sources, and descriptions suitable for the formation of silicone elastomers and foams.

TABLE 10

| Trade Name | Source | Description |
|---|---|---|
| LIM 6010A | General Electric | Vinyl-terminated polydimethyl- |
| | | siloxane compounded with filler |
| | | and catalyst |
| | | Viscosity = 30,000 cp |
| | | Extrusion Rate = 225 g/min |
| LIM 6010B | General Electric | Vinyl-terminated polydimethyl- |
| | | siloxane and Hydride-terminated |
| | | polydimethylsiloxane |
| | | compounded with filler/ |
| | | crosslinker |
| | | Viscosity = 30,000 cps |
| | | Extrusion Rate = 225 g/min |
| DC-200 | Dow Corning | Polydimethylsiloxane fluid |
| | | Viscosity = 20-100 centistokes |
| SFD-119 | Dow Corning | Vinyl-terminated polydimethyl- |
| | | siloxane |
| | | Viscosity = 450 cps |
| RTV 609 | GE Silicones | Linear vinyl-terminated polydi- |
| | | methylsiloxane |
| | | Viscosity = 3500 cps |
| SYLGARD 527 | Dow Corning | Polyorganosiloxane gel |
| Gel A | | formulation (two-part) |
| | | Viscosity = 425 cps |
| SYLGARD 527 | Dow Corning | Polyorganosiloxane gel |
| Gel B | | formulation (two-part) |
| | | Viscosity = 425 cps |
| SYLGARD 182— | Dow Corning | Vinyl-terminated polydimethyl- |
| Base | | siloxane |
| | | Viscosity = 3900 cps |
| SYLGARD 182— | Dow Corning | Hydride-terminated polydi- |
| Curing Agent | | methylsiloxane (Crosslinking |
| | | agent) |
| | | Viscosity = 3900 cps |
| SYLOFF 4000 | Dow Corning | Platinum catalyst |
| AG SF-20 | PQ Corp. | Silver-coated hollow ceramic |
| | | microspheres |
| | | Average particle Size = 45 |
| | | micrometers |
| 2429S | PQ Corp. | Silver coated solid glass spheres |
| | | Average particle size = 92 |
| | | micrometers |
| SA270720 | PQ Corp. | Silvered aluminum flakes |
| | | Average particle size = 44 |
| | | micrometers |
| SC325P17 | PQ Corp. | Silver coated copper powder |
| | | Average particle size = 45 |
| | | micrometers |
| S3000-S3M | PQ Corp. | Silver coated solid glass spheres |
| | | Average particle size = 42 |
| | | micrometers |
| AG clad filament | PQ Corp. | Silver coated glass fibers |
| | | 763 micrometers screen size |
| AVCARB 401 | | Carbon fibers |
| | | Diameter = 7 micrometers |
| 75% NCG | Novamet | 75% Nickel coated graphite |
| | | powder |
| | | Average particle size = 45 |
| | | micrometers |
| 60% NCG | Novamet | 60% Nickel coated graphite |
| | | powder |
| | | Average particle size = 90 |
| | | micrometers |
| SH230S33 | PQ Corp. | Silver coated hollow glass |
| | | spheres |
| | | Average particle size = 43 |
| | | micrometers |
| SH400S33 | PQ Corp. | Silver coated hollow glass |
| | | spheres |
| | | Average particle size = 15 |
| | | micrometers |
| AGSL-150-30-TRD | PQ Corp. | 30% Silver coated hollow |
| | | ceramic microsphere |
| | | Average particle size = 91 |
| | | micrometers |
| AGSL-150-16-TRD | PQ Corp. | 16% Silver coated hollow |
| | | ceramic microsphere |
| | | Average particle size = 91 |
| | | micrometers |
| Carbon nanotubes | Nanostructured | Electrically conductive filler |
| | and Amorphous | |
| | Materials Inc | |

The components as shown in Tables 11 through 16(all in parts by weight) are mixed by hand, then coated onto a roll-over-roll coater between two layers of release liner and cured between about 100° C. and about 140° C., for example, for about 15 to about 20 minutes.

To make solid elastomers and eliminate all air entrapped due to mixing, the reactive composition may be degassed, for example under vacuum.

Table 11 shows formulations having different electrically conductive fillers including carbon nanotubes in the LIM 6010 A&B silicone system.

TABLE 11

| | Sample Number | | | | | | |
|---|---|---|---|---|---|---|---|
| Component | 6 | 7 | 8 | 9 | 10 | 11 | 12 |
| LIM 6010A | 19.23 | 9.00 | 21.28 | 40 | 20.83 | 37.04 | 10.88 |
| LIM 6010B | 19.23 | 9.00 | 21.28 | 40 | 20.83 | 37.04 | 10.88 |
| SA270S20 | 58.54 | 0 | 0 | 0 | 0 | 0 | 0 |
| SC325P17 | 0 | 78.2 | 0 | 0 | 0 | 0 | 0 |
| S3000-S3M | 0 | 0 | 54.44 | 0 | 0 | 0 | 0 |
| SH230S33 | 0 | 0 | 0 | 17 | 0 | 0 | 0 |
| Ag Clad Filament | 0 | 0 | 0 | 0 | 55.34 | 0 | 0 |
| AGSF20 | 0 | 0 | 0 | 0 | 0 | 22.92 | 0 |
| 75% NCG | 0 | 0 | 0 | 0 | 0 | 0 | 75.24 |
| Carbon nanotubes | 3 | 3 | 3 | 3 | 3 | 3 | 3 |
| TOTAL | 100 | 100 | 100 | 100 | 100 | 100 | 100 |

Table 12 shows a combination of LIM 6010 LSR with silicon gel, using different electrically conductive fillers.

TABLE 12

| | Sample Number | | | | | | |
|---|---|---|---|---|---|---|---|
| Component | 13 | 14 | 15 | 15 | 16 | 17 | 18 |
| LIM 6010A | 29 | 21.75 | 14.5 | 10.99 | 11.6 | 7.25 | 6.5 |
| LIM 6010B | 29 | 21.75 | 14.5 | 10.99 | 11.6 | 7.25 | 6.5 |
| SYLGARD | 0 | 7.25 | 14.5 | 16.49 | 17.4 | 21.75 | 13.5 |
| 527 GEL A | | | | | | | |
| SYLGARD | 0 | 7.25 | 14.5 | 16.49 | 17.4 | 21.75 | 13.5 |
| 527 GEL B | | | | | | | |
| SYLGARD | 0 | 0 | 0 | 0 | 0 | 0 | 0.15 |
| 182 | | | | | | | |
| SYLGARD | 0 | 0 | 0 | 0 | 0 | 0 | 0.05 |
| 182 | | | | | | | |
| AGSF 20 | 42 | 41 | 40 | 39 | 38 | 37 | 36.5 |
| Carbon | | 1 | 2 | 3 | 4 | 5 | 4 |
| Nanotubes | | | | | | | |
| TOTAL | 100 | 100 | 100 | 100 | 100 | 100 | 100 |

Table 13 demonstrates the effect of reactive (SFD119) and non-reactive fluids (DC200) on the electrical properties of the silicone elastomers and foams.

TABLE 13

| Component/ | | | | | | | | |
|---|---|---|---|---|---|---|---|---|
| Sample # | 19 | 20 | 21 | 22 | 23 | 24 | 25 | 26 |
| LIM 6010A | 26.5 | 24 | 21.5 | 26.5 | 24 | 21.5 | 31.77 | 28.5 |
| LIM 6010B | 26.5 | 24 | 21.5 | 26.5 | 24 | 21.5 | 31.77 | 28.5 |
| SFD 119 | 5 | 10 | 15 | 0 | 0 | 0 | 0 | 0 |
| DC 200 | 0 | 0 | 0 | 5 | 10 | 15 | 33.44 | 38 |
| AGSF20 | 42 | 40 | 38 | 42 | 40 | 38 | | |
| Carbon | | 2 | 4 | | 2 | 4 | 3 | 5 |
| Nanotubes | | | | | | | | |
| TOTAL | 100 | 100 | 100 | 100 | 100 | 100 | 100 | 100 |

Electrical resistivity and Durometer can be modified depending on required application, using a mixture of fillers. Table 14 shows this for silver coated ceramic micro spheres. All compositions are shown in weight percent.

TABLE 14

| | Sample Number | | | | | |
|---|---|---|---|---|---|---|
| Component | 27 | 28 | 29 | 30 | 31 | 32 |
| LIM 6010A | 9.25 | 9.50 | 10.50 | 11.50 | 12.50 | 13.50 |
| LIM 6010B | 9.25 | 9.50 | 10.50 | 11.50 | 12.50 | 13.50 |
| SYLGARD | 9.25 | 9.50 | 10.50 | 11.50 | 12.50 | 13.50 |
| 527 Gel A | | | | | | |
| SYLGARD | 9.25 | 9.50 | 10.50 | 11.50 | 12.50 | 13.50 |
| 527 Gel B | | | | | | |
| AGSL-150-30 | 60.0 | 50.0 | 39.0 | 27.0 | 17.0 | 6.0 |
| TRD | | | | | | |
| AGSF-20 | 0 | 7.0 | 14.0 | 21.0 | 28.0 | 35 |
| Carbon | 3 | 5 | 5 | 5 | 5 | 5 |
| Nanotubes | | | | | | |
| TOTAL | 103 | 100 | 100 | 100 | 100 | 100 |

Table 15 reflects silicone foam and elastomeric compositions having nickel coated graphite fibers and carbon nanotubes.

TABLE 15

| | Sample Number | | | | | |
|---|---|---|---|---|---|---|
| Components/ | 33 | 34 | 35 | 36 | 37 | 38 |
| LIM 6010A | 11.25 | 10 | 8.75 | 7.5 | 6.25 | 5 |
| LIM 6010B | 11.25 | 10 | 8.75 | 7.5 | 6.25 | 5 |
| SYLGARD 527 Gel A | 11.25 | 10 | 8.75 | 7.5 | 6.25 | 5 |
| SYLGARD 527 Gel B | 11.25 | 10 | 8.75 | 7.5 | 6.25 | 5 |
| 75% NCG | 50 | 55 | 60 | 65 | 70 | 75 |
| Carbon Nanotubes | 5 | 5 | 5 | 5 | 5 | 5 |
| TOTAL | 100 | 100 | 100 | 100 | 100 | 100 |

Table 16 shows a mixture of LSR, gel, and electrical conductive fillers that yield a suitable combination of viscosity, softness, and electrical resistivity. All compositions are shown in weight percent.

TABLE 16

Sample Number

| Components | 39 | 40 |
|---|---|---|
| LIM 6010A | 6.88 | 12.48 |
| LIM 6010B | 6.88 | 12.48 |
| SYLGARD 527 Gel A | 6.88 | 12.48 |
| SYLGARD 527 Gel B | 6.88 | 12.48 |
| SYLOFF 4000 | 0 | 0.20 |
| 75% NCG | 54.35 | 0 |
| 66% NCG | 13.13 | 0 |
| AGSL-150-30TRD | 0 | 44.90 |
| Carbon Nanotubes | 5.00 | 5.00 |
| TOTAL | 100 | 100 |

Exemplary properties for the above and other electrically conductive silicone foams, particularly electromagnetically shielding and/or electrostatically dissipative elastomers, are set forth in the Table 17 below.

TABLE 17

| | Silicone Foams | | |
|---|---|---|---|
| Property | Embodiment 1 | Embodiment 2 | Embodiment 3 |
| Density (pcf) | 41-40 | 4-30 | 8-26 |
| 25% CFD (psi) | 0.1-80 | 0.25-40 | 0.5-20 |
| Elongation (%) | ≧20 | ≧20 | ≧20 |
| Compression Set (%) | ≦30 | ≦20 | ≦15 |
| per ASTM 1056 | | | |
| Tensile Strength (pli) | ≧20 | ≧20 | ≧20 |

Exemplary physical properties for the above and other silicone elastomers, particularly electromagnetically shielding and/or electrostatically dissipative elastomers, are set forth in Table 18 below.

TABLE 18

| | Silicone Elastomers | | |
|---|---|---|---|
| Property | Embodiment 1 | Embodiment 2 | Embodiment 3 |
| Elongation (%) | ≧20 | ≧20 | ≧20 |
| Shore A Durometer | ≦80 | ≦60 | ≦40 |
| Compression Set (%) | ≦50 | ≦40 | ≦30 |
| per ASTM D395B | | | |
| Tensile Strength (pli) | ≧20 | ≧20 | ≧20 |
| per ASTM D412 | | | |

### Example 4

This example demonstrates the electrical resistivity of silicone elastomeric compositions containing carbon nanotubes. The compositions are shown in Table 19.

Sample 41 is a comparative example containing above 70% of powdered graphite as the conductive filler.

Sample 42 was mixed by hand using a spatula. The sample was cast on a polycarbonate film and then cured in an oven for 10 minutes at 93° C. (200° F.) followed by 10 minutes of curing at 123° C. (250° F.).

For samples 43 and 44, the Sylgard 182 base and the carbon nanotubes were mixed with tetrahydrofuran in an ultrasonic sonicator for 5 minutes at a power of 5 watts. The sonicator was obtained from Branson Sonifier. The mixture was dried in an oven at 50° C. for 30 minutes and mixed with Sylgard 182 curing agent (hardener) using a spatula. Sample was cast on polycarbonate film and then cured in an oven for 10 minutes at 93° C. (200° F.) followed by 10 minutes of curing at 123° C. (250° F.).

The electrical resistivity shown below in Table 21 was measured using the methods described above. The measurements made in the x-y direction reflect those made by cutting the sample and painting the exposed ends with silver conductive paint, while the z direction measurements are those made using the custom fabricated press using the procedure described above.

TABLE 19

| | Sample No. | | | |
|---|---|---|---|---|
| Components | 41 | 42 | 43 | 44 |
| Tetrahydrofuran | | 0 | 10 | 20 |
| Sylgard 182 base | | 85.55 | 86.95 | 86.95 |
| Sylgard 182 curing agent | | 8.58 | 8.69 | 8.69 |
| Carbon Nanotubes | | 5.88 | 4.34 | 4.34 |
| LIM 6010A | 6.88 | | | |
| LIM 6010B | 6.88 | | | |
| SYLGARD 527 Gel A | 6.88 | | | |
| SYLGARD 527 Gel B | 6.88 | | | |
| SYLOFF 4000 | 0 | | | |
| 75% NCG | 59.35 | | | |
| 66% NCG | 13.13 | | | |
| AGSL-150-30TRD | 0 | | | |
| TOTAL | 100 | 100 | 100 | 100 |
| Volume resistivity, | 0.0681 | 17.4 | 413 | 292 |
| z direction (ohm-cm) | | | | |
| Volume resistivity, | 18.5 | 3.5 | 16.0 | 30.2 |
| xy direction (ohm-cm) | | | | |

As may be seen from the Table 19, samples containing the carbon nanotubes display equivalent amounts of electrical conductivity as the comparative samples having much higher loadings of the conductive fillers. The ability of the carbon nanotubes to produce lower values of electrical resistivity at lower filler loadings permits the composition to retain its flexibility, ductility, and other properties inherent to the silicone elastomer.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A composition comprising
a polymeric foam; and
carbon nanotubes, wherein the composition has a volume resistivity of about 10⁻³ ohm-cm to about 10⁸ ohm-cm.

2. The composition of claim 1, wherein the polymeric foam comprises a thermoplastic resin, and wherein the thermoplastic resin is a polyacetal, polyacrylic, styrene acrylonitrile, acrylonitrile-butadiene-styrene, polycarbonate, polystyrene, polyethylene, polypropylene, polyethylene terephthalate, polybutylene terephthalate, polyamide, polyamideimide, polyarylate, polyurethane, ethylene propylene diene monomer rubber, ethylene propylene rubber, polyarylsulfone, polyethersulfone, polyarylene sulfide, polyvinyl chloride, polysulfone, polyetherimide, polytetrafluoroethylene, fluorinated ethylene propylene, polychlorotrifluoroethylene, polyvinylidene fluoride, polyvinyl fluoride, polyetherketone, polyether etherketone, polyether ketone ketone, or a combination comprising at least one of the foregoing thermoplastic resins.

3. The composition of claim 1, wherein the polymeric foam comprises a thermosetting resin, and wherein the thermosetting resin is a polyurethane, natural rubber, synthetic rubber, epoxy, phenolic, polyester, polyamide, silicone, or a combination comprising at least one of the foregoing thermosetting resins.

4. The composition of claim 1, wherein the polymeric foam comprises a blend of a thermoplastic resin and a thermosetting resin.

5. The composition of claim 1, wherein the polymeric foam is a polyurethane foam, polyolefin foam, silicone foam, or a combination comprising at least one of the foregoing foams.

6. The composition of claim 1, wherein the carbon nanotubes are vapor grown carbon fibers, multiwall nanotubes, single wall nanotubes, or a combination comprising at least one of the foregoing carbon nanotubes.

7. The composition of claim 1, wherein the composition comprises about 0.0001 to about 50 wt % carbon nanotubes.

8. The composition of claim 1, wherein the composition has a density of less than 65 pounds per cubic foot and a void content of greater than or equal to about 70 volume percent.

9. The composition of claim 1, wherein the composition has an electromagnetic shielding capacity of greater than or equal to about 50 dB.

10. An electromagnetically shielding and/or electrostatically dissipative and/or electrically conductive article formed from the composition of claim 1.

11. The composition of claim 5, wherein the polyurethane foam has a density of about 1 to about 50 pounds per cubic foot, an elongation to break of greater than or equal to about 20%, and a compression set of less than or equal to about 30.

12. The composition of claim 5, wherein the polyolefin foam has a density of about 1 to about 20 pounds per cubic foot, an elongation to break of greater than or equal to about 100% and a compression set of less than or equal to about 70%.

13. The composition of claim 5, wherein the silicone foam has a density of about 4 to about 30 pounds per cubic foot, an elongation to break of greater than or equal to about 50% and a compression set at 50% of less than or equal to about 30.

14. A composition comprising
an elastomer; and
carbon nanotubes, wherein the composition has a volume resistivity of about 10⁻³ ohm-cm to about 10³ ohm-cm.

15. The composition of claim 14, wherein the elastomer comprises a thermosetting resin and/or a thermoplastic resin, wherein the thermosetting resin is styrene butadiene rubber, polyurethane or silicone or a combination comprising one of the foregoing thermosetting resins and wherein the thermoplastic resin is ethylene propylene diene monomer, ethylene propylene rubber, or elastomers derived from polyacrylics, polyurethanes, polyolefins, polyvinyl chlorides, or combinations comprising at least one of the foregoing thermoplastic resins.

16. The composition of claim 14, having a Shore A Durometer of less than 80 and an elongation to break of greater than 100%.

17. The composition of claim 14, wherein the carbon nanotubes are vapor grown carbon fibers, multiwall nanotubes, single wall nanotubes, or a combination comprising at least one of the foregoing carbon nanotubes.

18. The composition of claim 14, comprising about 0.0001 to about 50 wt % carbon nanotubes.

19. An electromagnetically shielding and/or electrostatically dissipative and/or electrically conductive article formed from the composition of claim 14.

20. A method of manufacturing a polymeric foam, comprising:
frothing a liquid composition comprising a polyisocyanate component, an active hydrogen-containing component reactive with the polyisocyanate component, a surfactant, a catalyst, and carbon nanotubes; and
curing the froth to produce a polyurethane foam having a density of about 1 to about 50 pounds per cubic foot, an elongation of greater than or equal to about 20% and a compression set of less than or equal to about 30.

21. A method of manufacturing a polymeric foam comprising:
extruding a mixture comprising an essentially linear single site initiated polyolefin, carbon nanotubes, a blowing agent and an optional curing agent; and
blowing the mixture to produce a foam having a density of about 1 to about 20 pounds per cubic foot, an elongation of greater than or equal to about 100% and a compression set of less than or equal to about 70.

22. The method of claim 21, wherein the polyolefin has density of about 0.86 g-cm⁻³ to about 0.96 g-cm⁻³, a melt index of about 0.5 dg/min to about 100 dg/min, a molecular weight distribution of about 1.5 to about 3.5, and a composition distribution breadth index greater than or equal to about 45 percent.

23. A method of manufacturing a polymeric foam comprising:
extruding a mixture comprising a polysiloxane polymer having hydride substituents, carbon nanotubes, a blowing agent and a platinum based catalyst; and
blowing the mixture to produce a silicone foam having a density of about 4 to about 30 pounds per cubic foot, an elongation of greater than or equal to about 50% and a compression set at 50% of less than or equal to about 30.

24. A method of manufacturing a polymeric foam comprising:
metering a composition comprising a polysiloxane polymer having hydride substituents, carbon nanotubes, a blowing agent and a platinum based catalyst into a mold or a continuous coating line; and
foaming the composition in the mold or on the continuous coating line.
